(19) United States
(12) Patent Application Publication
(10) Pub. No.: US 2023/0052221 A1
(43) Pub. Date: Feb. 16, 2023

(54) FREQUENCY HOPPING OR MULTI-BEAM TRANSMISSIONS FOR PHYSICAL UPLINK CHANNEL REPETITION ACROSS MULTIPLE COMPONENT CARRIERS

(71) Applicant: QUALCOMM Incorporated, San Diego, CA (US)

(72) Inventors: Mostafa KHOSHNEVISAN, San Diego, CA (US); Yi HUANG, San Diego, CA (US); Hung Dinh LY, San Diego, CA (US)

(21) Appl. No.: 17/805,779

(22) Filed: Jun. 7, 2022

Related U.S. Application Data
(60) Provisional application No. 63/260,298, filed on Aug. 16, 2021.

(51) Int. Cl. H04B 1/713; H04W 72/04; H04W 72/12

(52) U.S. Cl. CPC H04B 1/713; H04W 72/0413; H04W 72/0453; H04W 72/1268; H04L 1/18

(57) ABSTRACT

Various aspects of the present disclosure generally relate to wireless communication. In some aspects, a user equipment (UE) may receive an indication of a configuration for frequency hopping across repetitions of a physical uplink control channel (PUCCH) transmitted via a plurality of component carriers, wherein the plurality of component carriers includes at least a first component carrier and a second component carrier. The UE may transmit the repetitions of the PUCCH in accordance with the configuration. Numerous other aspects are described.

### CROSS-REFERENCE TO RELATED APPLICATION

This Patent Application claims priority to U.S. Provisional Pat. Application No. 63/260,298, filed on Aug. 16, 2021, titled “FREQUENCY HOPPING OR MULTI-BEAM TRANSMISSIONS FOR PHYSICAL UPLINK CHANNEL REPETITION ACROSS MULTIPLE COMPONENT CARRIERS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for frequency hopping or multi-beam transmissions for physical uplink channel repetition across multiple component carriers.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a configuration for frequency hopping across repetitions of a physical uplink control channel (PUCCH) transmitted via a plurality of component carriers, wherein the plurality of component carriers includes at least a first component carrier and a second component carrier. The method may include transmitting the repetitions of the PUCCH in accordance with the configuration.

Some aspects described herein relate to a method of wireless communication performed by a network node. The method may include transmitting an indication of a configuration for frequency hopping across repetitions of a PUCCH transmitted via a plurality of component carriers, wherein the plurality of component carriers includes at least a first component carrier and a second component carrier. The method may include receiving the repetitions of the PUCCH in accordance with the configuration.

Some aspects described herein relate to a method of wireless communication performed by a UE. The method may include receiving an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters. The method may include transmitting the first set of repetitions of the PUCCH and the second set of repetitions of the PUCCH in accordance with the configuration, wherein at least one of the first set of repetitions of the PUCCH or the second set of repetitions of the PUCCH is transmitted with the first set of transmission parameters and the second set of transmission parameters at different slots or at different sub-slots.

Some aspects described herein relate to a method of wireless communication performed by a network node. The method may include transmitting an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters. The method may include receiving the first set of repetitions of the PUCCH and the second set of repetitions of the PUCCH in accordance with the configuration, wherein at least one of the first set of repetitions of the PUCCH or the second set of repetitions of the PUCCH is transmitted with the first set of transmission parameters and the second set of transmission parameters at different slots or at different sub-slots.

Some aspects described herein relate to a UE for wireless communication. The user equipment may include a memory and one or more processors coupled to the memory. The one or more processors may be configured to receive an indication of a configuration for frequency hopping across repetitions of a PUCCH transmitted via a plurality of component carriers, wherein the plurality of component carriers includes at least a first component carrier and a second component carrier. The one or more processors may be configured to transmit the repetitions of the PUCCH in accordance with the configuration.

Some aspects described herein relate to a network node for wireless communication. The network node may include a memory and one or more processors coupled to the memory. The one or more processors may be configured to transmit an indication of a configuration for frequency hopping across repetitions of a PUCCH transmitted via a plurality of component carriers, wherein the plurality of component carriers includes at least a first component carrier and a second component carrier. The one or more processors may be configured to receive the repetitions of the PUCCH in accordance with the configuration.

Some aspects described herein relate to a UE for wireless communication. The UE may include a memory and one or more processors coupled to the memory. The one or more processors may be configured to receive an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters. The one or more processors may be configured to transmit the first set of repetitions of the PUCCH and the second set of repetitions of the PUCCH in accordance with the configuration, wherein at least one of the first set of repetitions of the PUCCH or the second set of repetitions of the PUCCH is transmitted with the first set of transmission parameters and the second set of transmission parameters at different slots or at different sub-slots.

Some aspects described herein relate to a network node for wireless communication. The network node may include a memory and one or more processors coupled to the memory. The one or more processors may be configured to transmit an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters. The one or more processors may be configured to receive the first set of repetitions of the PUCCH and the second set of repetitions of the PUCCH in accordance with the configuration, wherein at least one of the first set of repetitions of the PUCCH or the second set of repetitions of the PUCCH is transmitted with the first set of transmission parameters and the second set of transmission parameters at different slots or at different sub-slots.

Some aspects described herein relate to a non-transitory computer-readable medium that stores a set of instructions for wireless communication by a UE. The set of instructions, when executed by one or more processors of the UE, may cause the UE to receive an indication of a configuration for frequency hopping across repetitions of a PUCCH transmitted via a plurality of component carriers, wherein the plurality of component carriers includes at least a first component carrier and a second component carrier. The set of instructions, when executed by one or more processors of the UE, may cause the UE to transmit the repetitions of the PUCCH in accordance with the configuration.

Some aspects described herein relate to a non-transitory computer-readable medium that stores a set of instructions for wireless communication by a network node. The set of instructions, when executed by one or more processors of the network node, may cause the network node to transmit an indication of a configuration for frequency hopping across repetitions of a PUCCH transmitted via a plurality of component carriers, wherein the plurality of component carriers includes at least a first component carrier and a second component carrier. The set of instructions, when executed by one or more processors of the network node, may cause the network node to receive the repetitions of the PUCCH in accordance with the configuration.

Some aspects described herein relate to a non-transitory computer-readable medium that stores a set of instructions for wireless communication by a one or more instructions that, when executed by one or more processors of an UE. The set of instructions, when executed by one or more processors of the one or more instructions that, when executed by one or more processors of an UE, may cause the one or more instructions that, when executed by one or more processors of an UE to receive an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters. The set of instructions, when executed by one or more processors of the one or more instructions that, when executed by one or more processors of an UE, may cause the one or more instructions that, when executed by one or more processors of an UE to transmit the first set of repetitions of the PUCCH and the second set of repetitions of the PUCCH in accordance with the configuration, wherein at least one of the first set of repetitions of the PUCCH or the second set of repetitions of the PUCCH is transmitted with the first set of transmission parameters and the second set of transmission parameters at different slots or at different sub-slots.

Some aspects described herein relate to a non-transitory computer-readable medium that stores a set of instructions for wireless communication by a network node. The set of instructions, when executed by one or more processors of the network node, may cause the network node to transmit an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters. The set of instructions, when executed by one or more processors of the network node, may cause the network node to receive the first set of repetitions of the PUCCH and the second set of repetitions of the PUCCH in accordance with the configuration, wherein at least one of the first set of repetitions of the PUCCH or the second set of repetitions of the PUCCH is transmitted with the first set of transmission parameters and the second set of transmission parameters at different slots or at different sub-slots.

Some aspects described herein relate to an apparatus for wireless communication. The apparatus may include means for receiving an indication of a configuration for frequency hopping across repetitions of a PUCCH transmitted via a plurality of component carriers, wherein the plurality of component carriers includes at least a first component carrier and a second component carrier. The apparatus may include means for transmitting the repetitions of the PUCCH in accordance with the configuration.

Some aspects described herein relate to an apparatus for wireless communication. The apparatus may include means for transmitting an indication of a configuration for frequency hopping across repetitions of a PUCCH transmitted via a plurality of component carriers, wherein the plurality of component carriers includes at least a first component carrier and a second component carrier. The apparatus may include means for receiving the repetitions of the PUCCH in accordance with the configuration.

Some aspects described herein relate to an apparatus for wireless communication. The apparatus may include means for receiving an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters. The apparatus may include means for transmitting the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots.

Some aspects described herein relate to an apparatus for wireless communication. The apparatus may include means for transmitting an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters. The apparatus may include means for receiving the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of physical channels and reference signals in a wireless network, in accordance with the present disclosure.

FIG. 4 is a diagram illustrating an example of physical uplink control channel (PUCCH) repetition across multiple component carriers, in accordance with the present disclosure.

FIGS. 5-8 are diagrams illustrating examples associated with frequency hopping for physical uplink channel repetition across multiple component carriers, in accordance with the present disclosure.

FIGS. 9-12 are diagrams illustrating examples associated with multi-beam transmissions for physical uplink channel repetition across multiple component carriers, in accordance with the present disclosure.

FIGS. 13 and 14 are diagrams illustrating example processes associated with frequency hopping for physical uplink channel repetition across multiple component carriers, in accordance with the present disclosure.

FIGS. 15 and 16 are diagrams illustrating example processes associated with multi-beam transmissions for physical uplink channel repetition across multiple component carriers, in accordance with the present disclosure.

FIGS. 17-20 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

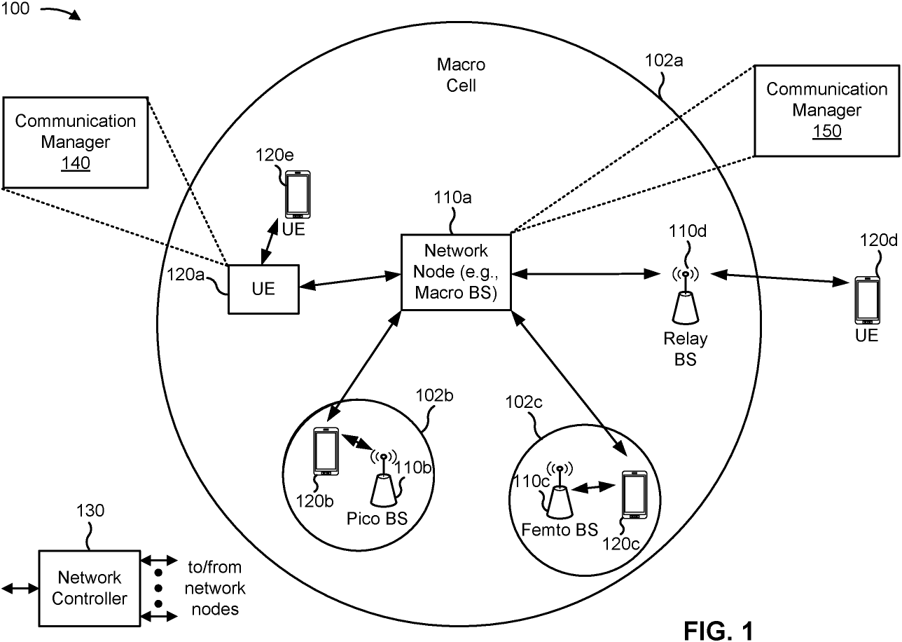

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A network node 110 is an entity that communicates with UEs 120. A network node 110 (sometimes referred to as a BS) may include, for example, an NR base station, an LTE base station, a Node B, an eNB (e.g., in 4G), a gNB (e.g., in 5G), an access point, and/or a transmission reception point (TRP). Each network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used.

A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro base station. A network node 110 for a pico cell may be referred to as a pico base station. A network node 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A network node may support one or multiple (e.g., three) cells.

In some examples, a cell may not necessarily be stationary, and the geographic area of the cell may move according to the location of a network node 110 that is mobile (e.g., a mobile base station). In some examples, the network nodes 110 may be interconnected to one another and/or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a network node 110 or a UE 120) and send a transmission of the data to a downstream station (e.g., a UE 120 or a network node 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A network node 110 that relays communications may be referred to as a relay station, a relay base station, a relay, or the like.

The wireless network 100 may be a heterogeneous network that includes network nodes 110 of different types, such as macro base stations, pico base stations, femto base stations, relay base stations, or the like. These different types of network nodes 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz - 7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz - 114.25 GHz), and FR5 (114.25 GHz - 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may perform one or more operations associated with frequency hopping or multi-beam transmissions across multiple component carriers. Additionally, or alternatively, the communication manager 140 may perform one or more other operations described herein.

In some aspects, the network node 110 may include a communication manager 150. As described in more detail elsewhere herein, the communication manager 150 may perform one or more operations associated with frequency hopping or multi-beam transmissions across multiple component carriers. Additionally, or alternatively, the communication manager 150 may perform one or more other operations described herein.

As described herein, a node, which may be referred to as a “node,” a “network node,” or a “wireless node,” may be a base station (e.g., network node 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

As indicated above, FIG. 1 is provided as an example. Other examples may differ from what is described with regard to FIG. 1.

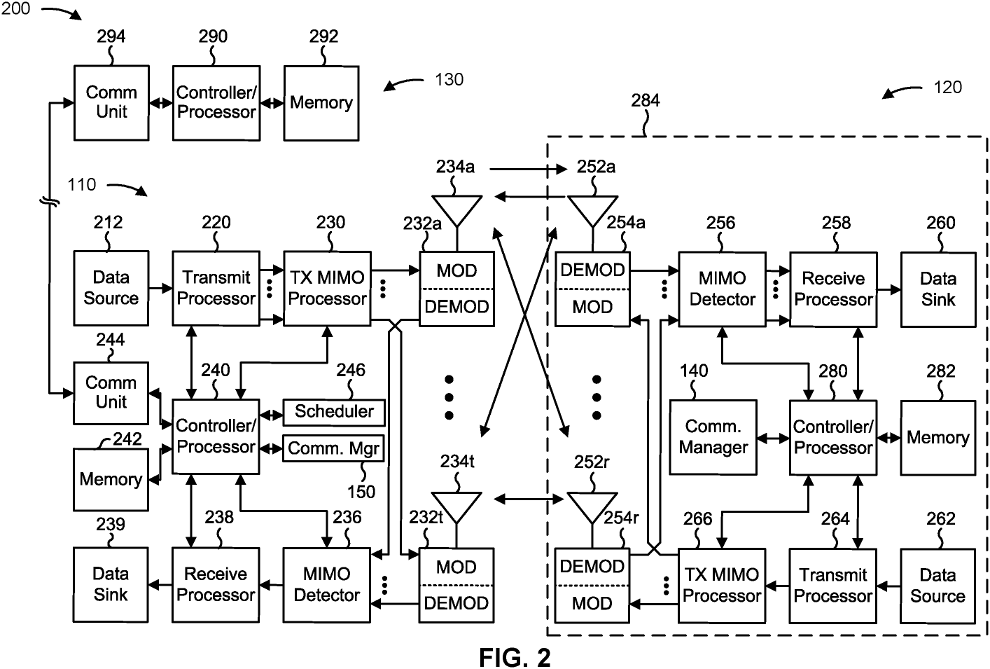

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T ≥ 1). The UE 120 may be equipped with a set of antennas 252a through 252r, such as R antennas (R ≥ 1).

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., Tmodems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

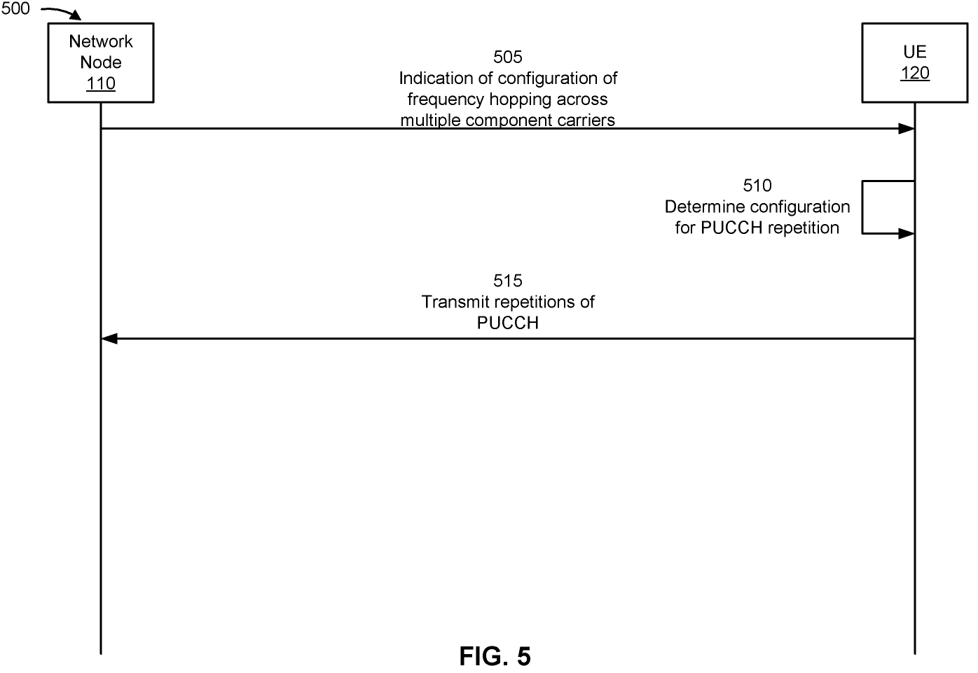

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-20).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-20).

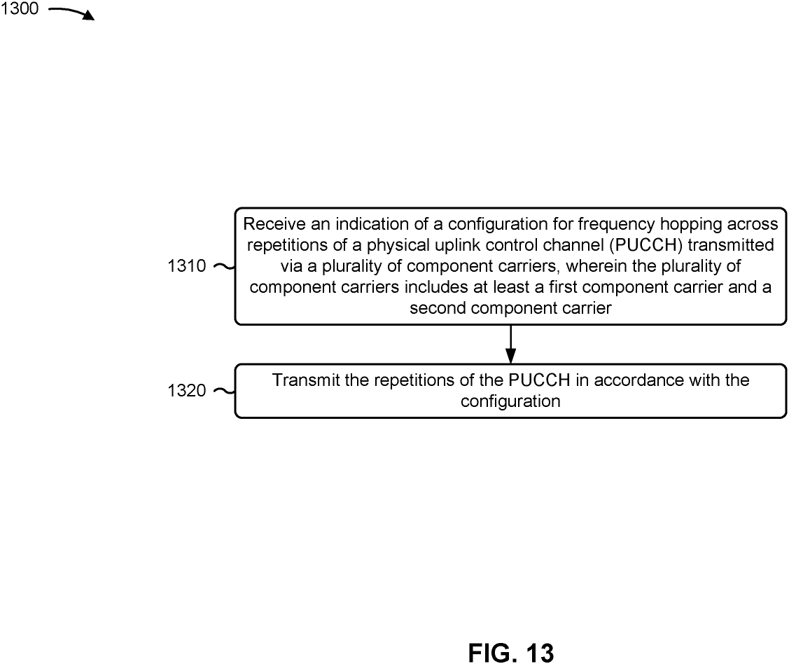

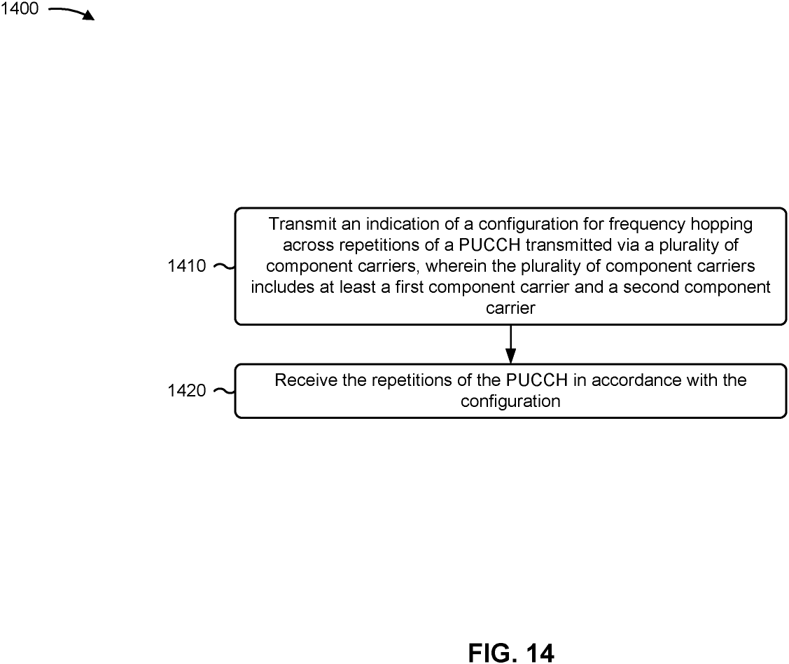

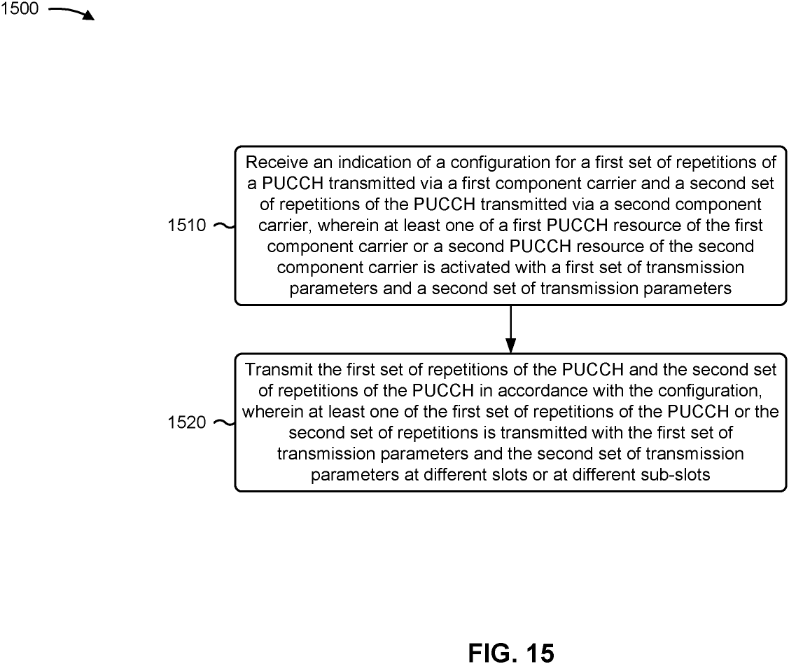

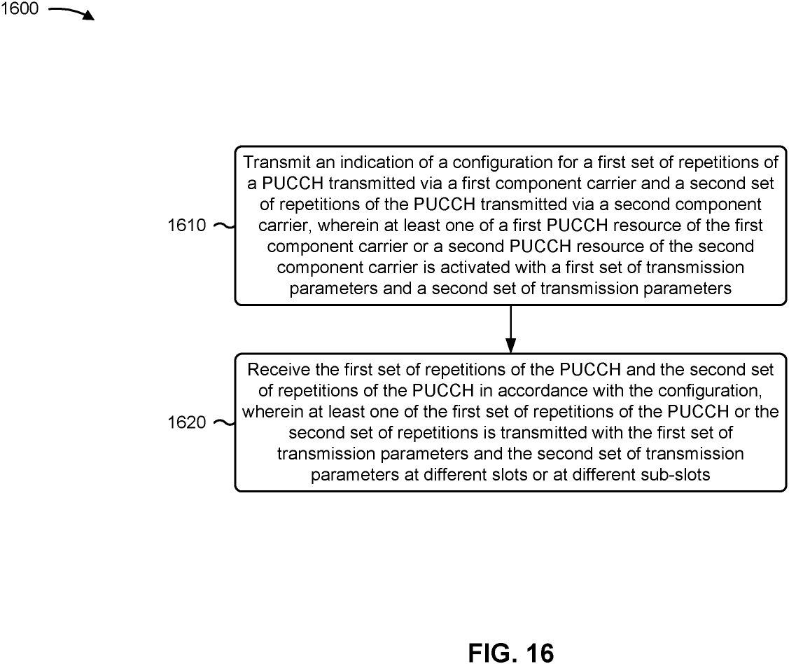

The controller/processor 240 of the network node 110, the controller/processor 280 of the UE 120, and/or any other component(s) of FIG. 2 may perform one or more techniques associated with frequency hopping or multi-beam transmissions for physical uplink channel repetition across multiple component carriers, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, process 1500 of FIG. 15, process 1600 of FIG. 16, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, process 1500 of FIG. 15, process 1600 of FIG. 16, and/or other processes as described herein. In some examples, executing instructions may include running the instructions, converting the instructions, compiling the instructions, and/or interpreting the instructions, among other examples.

In some aspects, the UE 120 includes means for receiving an indication of a configuration for frequency hopping across repetitions of a physical uplink control channel (PUCCH) transmitted via a plurality of component carriers, wherein the plurality of component carriers includes at least a first component carrier and a second component carrier; and/or means for transmitting the repetitions of the PUCCH in accordance with the configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication of a configuration for frequency hopping across repetitions of a PUCCH transmitted via a plurality of component carriers, wherein the plurality of component carriers includes at least a first component carrier and a second component carrier; and/or means for receiving the repetitions of the PUCCH in accordance with the configuration. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE 120 includes means for receiving an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters; and/or means for transmitting the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters; and/or means for receiving the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, the term “network node” (e.g., the network node 110) may refer to an aggregated base station, a disaggregated base station, and/or one or more components of a disaggregated base station. For example, in some aspects, “network node” may refer to a control unit, a distributed unit, a plurality of control units, a plurality of distributed units, and/or a combination thereof. In some aspects, “network node” may refer to one device configured to perform one or more functions such as those described above in connection with the network node 110. In some aspects, “network node” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “network node” may refer to any one or more of those different devices. In some aspects, “network node” may refer to one or more virtual network nodes, one or more virtual network node functions, and/or a combination of thereof. For example, in some cases, two or more network node functions may be instantiated on a single device. In some aspects, “network node” may refer to one of the network node functions and not another. In this way, a single device may include more than one network node.

As indicated above, FIG. 2 is provided as an example. Other examples may differ from what is described with regard to FIG. 2.

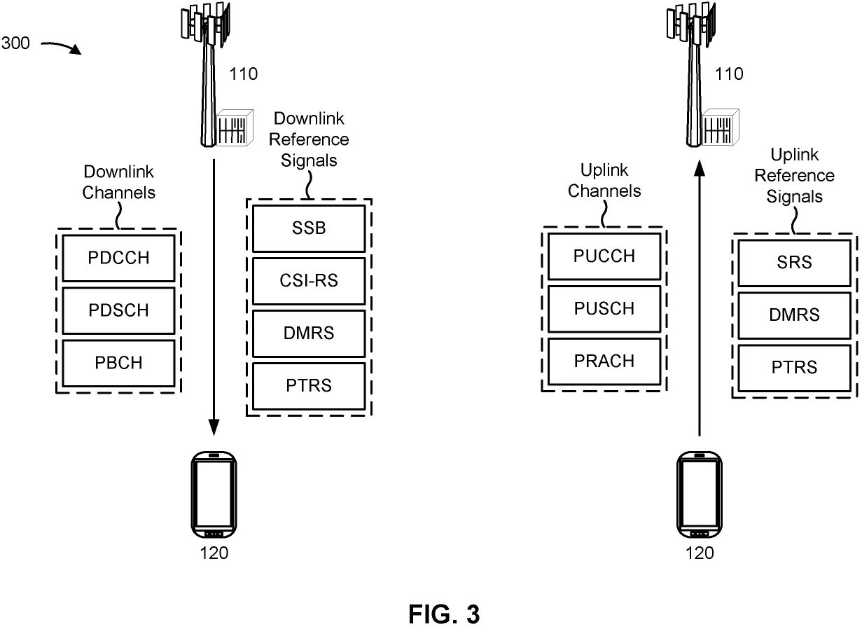

FIG. 3 is a diagram illustrating an example 300 of physical channels and reference signals in a wireless network, in accordance with the present disclosure. As shown in FIG. 3, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. For example, the UE 120 may transmit repetitions of UCI via a PUCCH across a plurality of component carriers (e.g., a first instance of the UCI in a first component carrier and a second instance (a repetition) of the UCI in a second component carrier). The UCI may convey feedback information. For example, the UE 120 may transmit acknowledgement (ACK) or negative acknowledgement (NACK) feedback (e.g., ACK/NACK feedback or ACK/NACK information) in UCI on the PUCCH and/or the PUSCH.

Different PUCCH formats may be possible. For example, PUCCH formats with different durations, payload size ranges, and multiplexing capabilities are defined for 5G communications (e.g., PUCCH formats 0 to 4), as described in more detail with regard to 3GPP Technical Specification (TS) 38.213, Release 16, Version 16.6.0, Section 9.2.2. The UE 120 may receive radio resource control (RRC) signaling configuring resources (e.g., up to 128 resources) for PUCCH communication and a PUCCH format to use in each resource. In scenarios where hybrid automatic repeat request (HARQ) -ACK feedback is multiplexed in a PUCCH resource, the UE 120 may receive DCI (e.g., a DCI format that schedules a PDSCH and a corresponding PUCCH for HARQ-ACK feedback) that indicates a PUCCH resource indicator (PRI). In these scenarios, the UE 120 may select a PUCCH resource set based at least in part on a UCI payload and may select a PUCCH resource within the PUCCH resource set based at least in part on the PRI. In this way, the UE 120 may dynamically select PUCCH resources for HARQ-ACK transmission.

PUCCH communications may be repeated across a plurality of slots for some PUCCH formats, such as PUCCH formats 1, 3, and 4. The UE 120 may receive an RRC indication of a quantity of repetitions to transmit for each PUCCH format. As a result, all PUCCH resources with a particular format may have the same quantity of repetitions. Moreover, the UE 120 may use the same PUCCH resource across all repetitions in different slots. In other words, the UE 120 may use the same symbols (e.g., the same starting symbol and length) in each slot in which the UE 120 transmits PUCCH repetitions. As a result, each PUCCH repetition may have the same quantity of coded bits and the same resource identifier (ID). The quantity of repetitions can be configured on a per PUCCH resource basis (rather than a per PUCCH format basis). In this case, the PRI in DCI may dynamically indicate a PUCCH resource with a particular quantity of repetitions, thereby enabling dynamic configuration of a quantity of PUCCH repetitions. “PUCCH repetitions” or repetitions of a “PUCCH communication” may refer to repetitions of the same UCI across a plurality of PUCCH resources.

The UE 120 may be configured with a single power adjustment state (e.g., a closed loop index l = 0) or two separate power adjustment states (e.g., a closed loop index of l = 0,1) for power adjustment for PUCCH transmission. When the UE 120 has two separate adjustment states, each PUCCH resource is configured and/or activated with a transmit power control (TPC) adjustment for l = 0 or l = 1. The UE 120 may maintain power adjustment states based at least in part on TPC commands received from the network node 110 in DCI. In other words, TPC commands are accumulated per power adjustment state. Accordingly, DCI formats that network node 110 uses to schedule downlink (e.g., a PDSCH) and uplink (e.g., a PUCCH for a HARQ-ACK response to the PDSCH), such as DCI format 1_0, 1_1, or 1_2, include a TPC field for closed loop power adjustment for a scheduled PUCCH. Similarly, network node 110 may use DCI format 2_2 (e.g., a group-common DCI) with a cyclic redundancy check (CRC) scrambled with a TPC-PUCCH-radio network temporary identifier (RNTI) to indicate a closed loop index and a TPC command for a group of UEs 120.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. The network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. The network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

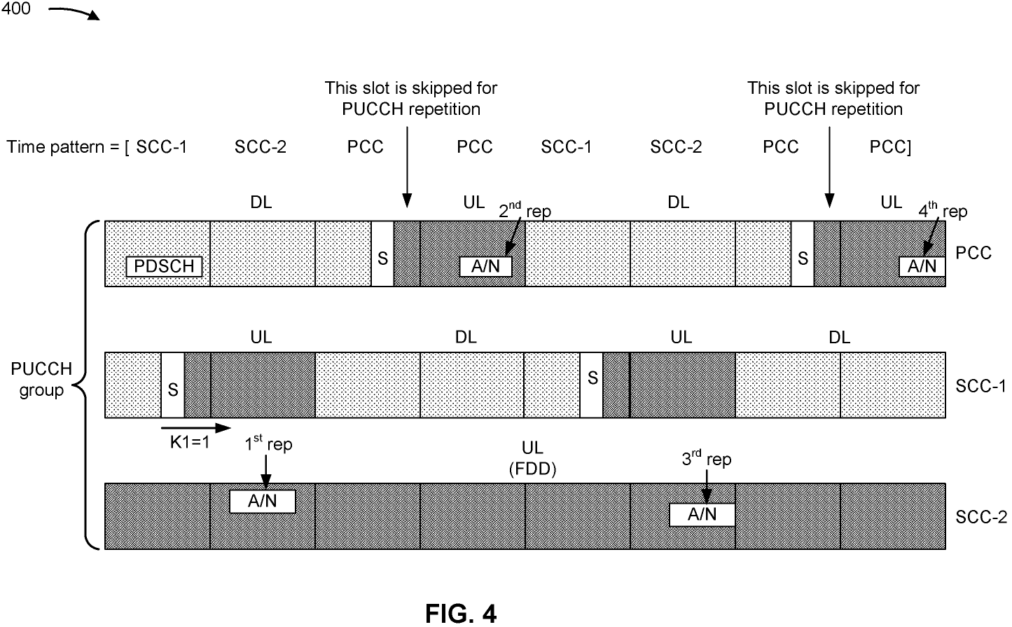

FIG. 4 is a diagram illustrating an example 400 of PUCCH repetition across multiple component carriers, in accordance with the present disclosure.

In some communications systems, in uplink carrier aggregation, a UE may transmit a PUCCH in a primary component carrier (PCC) of a PUCCH group and not in any secondary component carriers (SCCs) (e.g., a first SCC, SCC-1, or a second SCC, SCC-2) of the PUCCH group. In other communications systems, the UE may switch between component carriers within a PUCCH group, such as switching between a PCC, a first SCC-1, and a second SCC-2. The UE may switch based at least in part on an indication received from a network node. The network node may indicate on which component carrier the UE is to transmit a repetition of a PUCCH in a slot. For example, the network node may transmit a DCI or an RRC message to indicate the component carrier on which the UE is to transmit a PUCCH or a PUCCH repetition in a slot. When using DCI (e.g., dynamic indication), the network node may set a field to provide the indication. When using RRC (e.g., semi-static indication), the network node may identify a time pattern that provides a periodicity for component carrier switching.

As shown in FIG. 4, the UE may receive a PDSCH on a PCC, and may transmit repetitions of a PUCCH (e.g., repetitions of UCI conveying a HARQ-ACK for the PDSCH) on the PCC and on SCC-2 in accordance with a component carrier switching configuration set by the network node (e.g., a time pattern for transmitting on the PCC, SCC-1, and SCC-2). In some cases, inter-slot frequency hopping may be enabled for a PUCCH format or a PUCCH resource. As an example, a PUCCH format configuration may indicate that inter-slot frequency hopping is enabled for PUCCH resources associated with the PUCCH format, a number of PUCCH repetitions to be transmitted, a starting resource block, and a second hop resource block. The UE may transmit the PUCCH starting from a first resource block provided by the starting resource block in slots numbered with an even number and may transmit the PUCCH starting from a second resource block provided by the next hop resource block in slots numbered with an odd number. However, when the UE is to transmit repetitions of the PUCCH via multiple component carriers, the PUCCH format configuration (as well as the PUCCH resource configuration) may fail to provide for performing inter-repetition frequency hopping (e.g., inter-slot or inter-sub-slot frequency hopping) across multiple component carriers.

Further, a component carrier or a PUCCH resource may be activated with multiple sets of transmission parameters. A set of transmission parameters may include multiple spatial relation information, multiple transmission beams, multiple TRPs, and/or multiple power control parameters. Without UE behavior defined for scenarios with multiple transmission parameters, the UE may transmit repetitions of a PUCCH in a manner different than what is expected by the network node, which can result in synchronization issues, dropped communications, or interference, among other examples.

As indicated above, FIG. 4 is provided as an example. Other examples may differ from what is described with respect to FIG. 4.

Some aspects described herein enable frequency hopping across multiple component carriers when transmitting PUCCH repetitions across the multiple component carriers. In some aspects, when the UE is configured to transmit a first set of PUCCH repetitions via a first component carrier and a second set of PUCCH repetitions via a second component carrier, the UE may perform frequency hopping separately across the first set of PUCCH repetitions via the first component carrier and across the second set of PUCCH repetitions via the second component carrier.

In some aspects, when the UE is configured to transmit a first set of PUCCH repetitions via a first component carrier and a second set of PUCCH repetitions via a second component carrier, the UE may perform frequency hopping across all repetitions (e.g., the first set of repetitions and the second set of repetitions) in both the first component carrier and the second component carrier. For example, the first set of repetitions may include N1 repetitions and the second set of repetitions may include N2 repetitions. The repetitions may be numbered from 0 to N1+N2-1 and even repetitions may transmitted in the first frequency hop and odd repetitions may be transmitted in the second frequency hop.

In some aspects, the location of the first frequency hop and the second frequency hop may depend on the component carrier on which the frequency hop is transmitted and/or a configuration of a corresponding PUCCH resource. In some aspects, the UE determines whether to perform frequency hopping or not based at least in part on a configuration of both the PUCCH resource of the first component carrier and the PUCCH resource of the second component carrier (or PUCCH formats associated with the PUCCH resource of the first component carrier and the PUCCH resource of the second component carrier). For example, frequency hopping across N1+N2 repetitions may be performed if at least one of the PUCCH resource of the first component carrier or the PUCCH resource of the second component carrier is configured with frequency hopping or if a reference component carrier (e.g., a component carrier with the lowest component carrier index) is configured with frequency hopping.

Further, some aspects described herein enable multi-beam transmissions across multiple component carriers when transmitting PUCCH repetitions across the multiple component carriers. In some aspects, when the UE is configured to transmit N1 PUCCH repetitions in a first component carrier (e.g., in PUCCH resource 1) and N2 PUCCH repetitions in a second component carrier (e.g., in PUCCH resource 2), if the PUCCH resource 1 and/or the PUCCH resource 2 are activated with two sets of transmission patterns (e.g., two sets of spatial relation information, two UL beams, or two sets of power control parameters), the UE transmits the N1 repetitions and/or the N2 repetitions with the two sets of transmission parameters at different slots or different sub-slots.

FIG. 5 is a diagram illustrating an example 500 associated with frequency hopping for PUCCH repetition across multiple component carriers, in accordance with the present disclosure. As shown in FIG. 5, example 500 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As further shown in FIG. 5, and by reference number 505, the network node 110 may transmit, and the UE 120 may receive, an indication of a configuration for frequency hopping across repetitions of a PUCCH transmitted via multiple component carriers. For example, the network node 110 may transmit, and the UE 120 may receive, an indication of a configuration for frequency hopping across repetitions of a PUCCH transmitted via a first component carrier and a second component carrier. The frequency hopping across the multiple component carriers may include inter-slot frequency hopping or inter-sub-slot frequency hopping across the multiple component carriers.

In some aspects, the configuration may be a semi-static configuration. For example, the network node 110 may configure, via RRC signaling, a set of PUCCH resources for frequency hopping across repetitions of a PUCCH per PUCCH format (e.g., frequency hopping is configured for all PUCCH resources associated with a particular PUCCH format). In some aspects, the indication may indicate that the configuration is to be utilized for PUCCH resources associated with a particular PUCCH format or for a set of PUCCH resources, among other examples.

In some aspects, the indication of the configuration may be a dynamic indication. For example, the indication may be included in or indicated by a PDCCH received by the UE 120. The PDCCH may indicate a first PUCCH resource of the first component carrier and/or a second PUCCH resource of the second component carrier. A configuration of the first PUCCH resource may indicate whether to perform frequency hopping across a first set of repetitions of the PUCCH transmitted via the first component carrier. A configuration of the second PUCCH resource may indicate whether to perform frequency hopping across a second set of repetitions of the PUCCH transmitted via the second component carrier.

As shown by reference number 510, the UE 120 may determine the configuration for performing frequency hopping for transmitting the repetitions of the PUCCH across the multiple component carriers. In some aspects, the UE 120 may determine whether to perform frequency hopping for transmitting the repetitions of the PUCCH across each component carrier of the multiple component carriers. For example, the multiple component carriers may include a first component carrier and a second component carrier and the UE 120 may determine, based at least in part on the configuration, whether to perform frequency hopping for transmitting repetitions of the PUCCH across only the first component carrier, only the second component carrier, or both of the first component carrier and the second component carrier.

In some aspects, whether to perform frequency hopping for transmitting the repetitions of the PUCCH across each component carrier of the multiple component carriers may be determined separately for each component carrier. For example, the indication may be included in or indicated by a PDCCH received by the UE 120. The PDCCH may indicate a first PUCCH resource of the first component carrier and a second PUCCH resource of the second component carrier. A configuration of the first PUCCH resource or a format associated with the first PUCCH resource may indicate whether to perform frequency hopping across a first set of repetitions of the PUCCH transmitted via the first component carrier. A configuration of the second PUCCH resource or a format associated with the second PUCCH resource may indicate whether to perform frequency hopping across a second set of repetitions of the PUCCH transmitted via the second component carrier.

In some aspects, the UE 120 may determine a first frequency hop and a second frequency hop for each component carrier for which frequency hopping is to be performed based at least in part on the configuration. In some aspects, the UE 120 may determine a first frequency hop and a second frequency hop on a per component carrier basis. For example, the UE 120 may determine a first frequency hop and a second frequency hop for a first component carrier, of the multiple component carriers, based at least in part on a PUCCH resource configuration associated with a PUCCH resource of the first component carrier. The PUCCH resource configuration may indicate a starting frequency hop corresponding to the first frequency hop and the second frequency hop. The configuration may indicate that M repetitions of the PUCCH are to be transmitted via the first component carrier. The M repetitions may be numbered from 0 to M-1 and even numbered repetitions may be transmitted in the first frequency hop and odd numbered repetitions may be transmitted in the second frequency hop. The UE 120 may determine the first frequency hop and the second frequency hop for each component carrier for which frequency hopping is to be performed in a manner similar to that described above.

In some aspects, the configuration may indicate that frequency hopping for the repetitions of the PUCCH is to be performed across repetitions transmitted via all of the multiple component carriers. In some aspects, the UE 120 determines whether to perform frequency hopping based at least in part on a configuration of PUCCH resources (or PUCCH formats associated with the PUCCH resources) of the multiple component carriers. For example, the configuration may indicate that frequency hopping across repetitions transmitted via all of the component carriers is performed if at least one of the PUCCH resources is configured with frequency hopping or if a reference component carrier (e.g., a component carrier having a lowest component carrier index relative to other component carriers of the multiple component carriers) is configured with frequency hopping, among other examples.

In some aspects, the configuration may indicate that M repetitions of the PUCCH are to be transmitted via the first component carrier, that N repetitions of the PUCCH are to be transmitted via the second component carrier, and that frequency hopping is to be performed across M+N repetitions of the PUCCH transmitted via the first component carrier and the second component carrier.

In some aspects, the M+N repetitions may be numbered from 0 to M+N-1 and even numbered repetitions may be transmitted in the first frequency hop and odd numbered repetitions may be transmitted in the second frequency hop. In some aspects, the location of the first frequency hop and the second frequency hop may depend on the component carrier on which the first frequency hop and the second frequency hop is to be transmitted and a configuration of a corresponding PUCCH resource.

In some aspects, the UE 120 may determine the component carrier for transmitting a repetition of the PUCCH based at least in part on an indication received from the network node 110. The network node 110 may indicate on which component carrier the UE 120 is to transmit a repetition of a PUCCH in a slot. For example, the network node 110 may transmit a DCI or an RRC message to indicate the component carrier on which the UE 120 is to transmit a repetition of the PUCCH. When using DCI (e.g., dynamic indication), the network node 110 may set a field to provide the indication of the component carrier for transmitting a repetition of the PUCCH. When using RRC (e.g., semi-static indication), the network node 110 may identify a time pattern that provides a periodicity for component carrier switching and the UE 120 may determine the component carrier for transmitting a repetition of the PUCCH based at least in part on the time pattern.

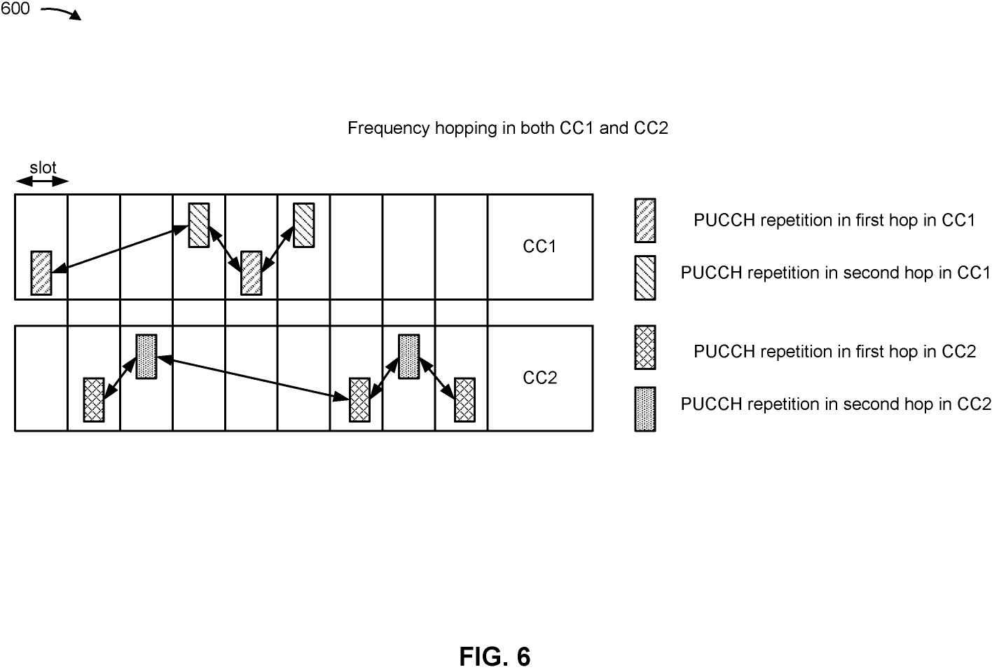

As shown by reference number 515, the UE 120 may transmit, and the network node 110 may receive, the repetitions of the PUCCH in accordance with the configuration. The PUCCH may transmit, and the network node 110 may receive, the repetitions of the PUCCH in accordance with the configuration as described elsewhere herein, for example, as described below with respect to FIGS. 6-8.

As indicated above, FIG. 5 is provided as an example. Other examples may differ from what is described with respect to FIG. 5.

FIGS. 6-8 are diagrams illustrating examples 600, 700, and 800, respectively, associated with performing frequency hopping for PUCCH repetition across multiple component carriers, in accordance with the present disclosure.

In some aspects, as shown in FIG. 6, the configuration may indicate that frequency hopping for the repetitions of the PUCCH is to be performed separately across repetitions transmitted via the first component carrier and across repetitions transmitted across the second component carrier. For example, the configuration may indicate that frequency hopping is to be performed across N repetitions of the PUCCH transmitted via the first component carrier CC1 and that frequency hopping is to be performed across M repetitions of the PUCCH transmitted via the second component carrier CC2.

A configuration associated with the first component carrier CC1, a format of a corresponding PUCCH resource of the first component carrier CC1, or the corresponding PUCCH resource of the first component carrier CC1 may indicate a first frequency hop and a second frequency hop for performing frequency hopping across the M repetitions of the PUCCH transmitted via the first component carrier CC1. The M repetitions may be numbered (e.g., from 0 to M) and even numbered repetitions of the M repetitions of the PUCCH may be transmitted in the first frequency hop and odd numbered repetitions of the M repetitions of the PUCCH may be transmitted in the second frequency hop.

Similarly, a configuration associated with the second component carrier CC2, a format of a corresponding PUCCH resource of the second component carrier CC2, or the corresponding PUCCH resource of the second component carrier CC2 may indicate a first frequency hop and a second frequency hop for performing frequency hopping across the N repetitions of the PUCCH transmitted via the second component carrier CC2. The N repetitions may be numbered (e.g., from 0 to N) and even numbered repetitions of the N repetitions of the PUCCH may be transmitted in the first frequency hop and odd numbered repetitions of the N repetitions of the PUCCH may be transmitted in the second frequency hop.

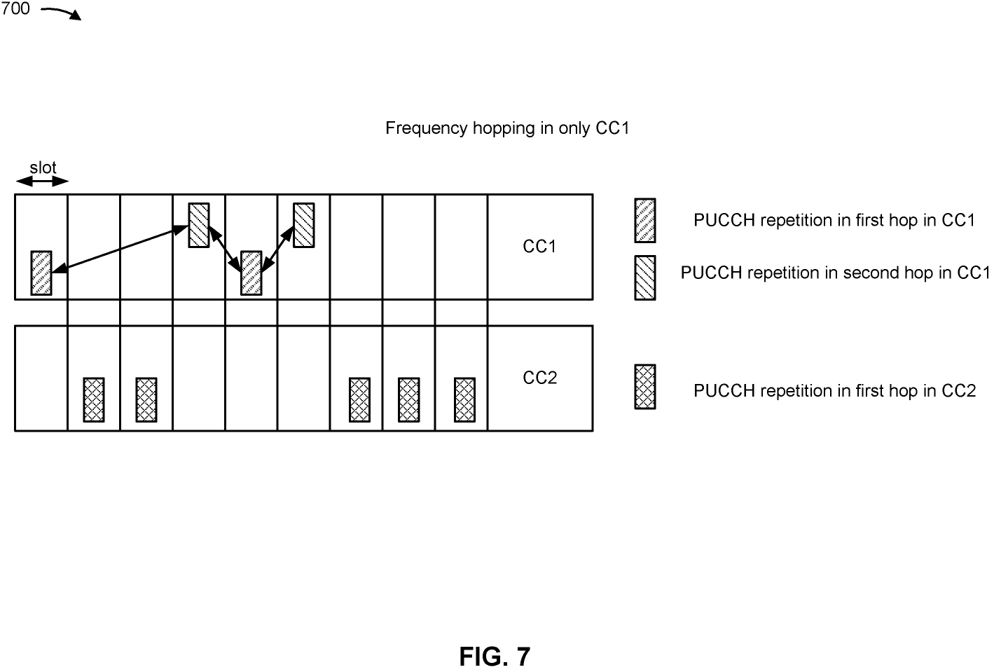

In some aspects, as shown in FIG. 7, the configuration may indicate that frequency hopping for the repetitions of the PUCCH is to be performed across repetitions transmitted via only one or more of the multiple component carriers. For example, as shown in FIG. 7, the configuration may indicate that frequency hopping is to be performed across N repetitions of the PUCCH transmitted via the first component carrier CC1 and that frequency hopping is not to be performed across M repetitions of the PUCCH transmitted via the second component carrier CC2.

A configuration associated with the first component carrier CC1, a format of a corresponding PUCCH resource of the first component carrier CC1, or the corresponding PUCCH resource of the first component carrier CC1 may indicate a first frequency hop and a second frequency hop for performing frequency hopping across the M repetitions of the PUCCH transmitted via the first component carrier CC1. The M repetitions may be numbered (e.g., from 0 to M) and even numbered repetitions of the M repetitions of the PUCCH may be transmitted in the first frequency hop and odd numbered repetitions of the M repetitions of the PUCCH may be transmitted in the second frequency hop.

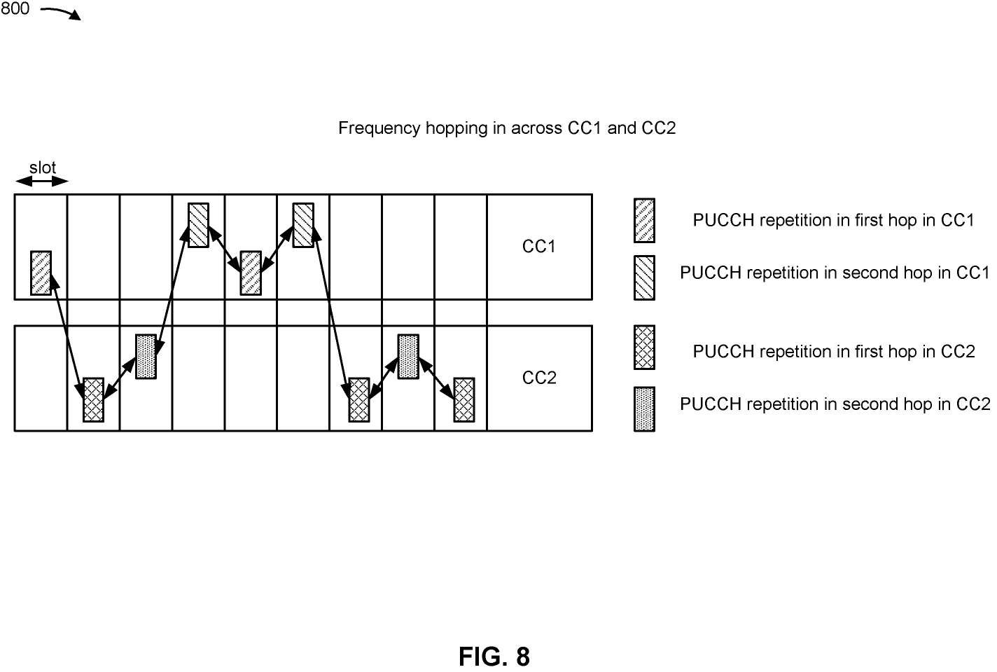

In some aspects, as shown in FIG. 8, the configuration may indicate that frequency hopping for the repetitions of the PUCCH is to be performed across repetitions transmitted via all of the multiple component carriers. For example, as shown in FIG. 8, the configuration may indicate that frequency hopping is to be performed across M+N repetitions of the PUCCH transmitted via the first component carrier CC1 and the second component carrier CC2.

A configuration associated with the first component carrier CC1, a format of a corresponding PUCCH resource of the first component carrier CC1, or the corresponding PUCCH resource of the first component carrier CC1 may indicate a first frequency hop for performing frequency hopping across the M repetitions of the PUCCH transmitted via the first component carrier CC1. Similarly, a configuration associated with the second component carrier CC2, a format of a corresponding PUCCH resource of the second component carrier CC2, or the corresponding PUCCH resource of the second component carrier CC2 may indicate a second frequency hop for performing frequency hopping across the N repetitions of the PUCCH transmitted via the second component carrier CC2. The M+N repetitions may be numbered (e.g., from 0 to M+N-1) and even numbered repetitions of the M+N repetitions of the PUCCH may be transmitted in the first frequency hop and odd numbered repetitions of the M+N repetitions of the PUCCH may be transmitted in the second frequency hop.

As indicated above, FIGS. 6-8 are provided as examples. Other examples may differ from what is described with respect to FIGS. 6-8.

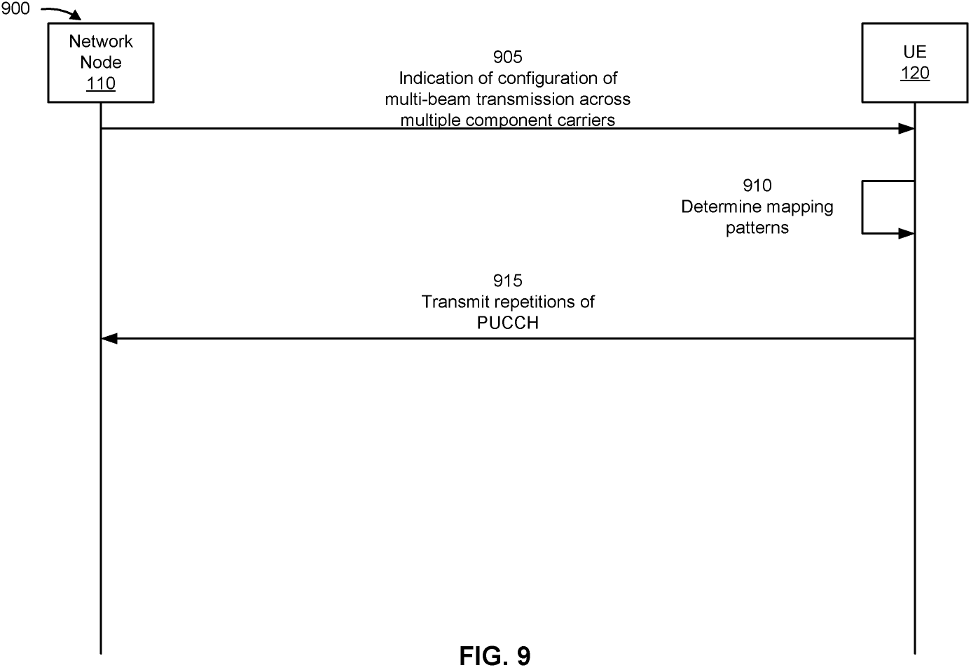

FIG. 9 is a diagram illustrating an example 900 associated with multi-beam transmissions for PUCCH repetition across multiple component carriers, in accordance with the present disclosure. As shown in FIG. 9, example 900 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As further shown in FIG. 9, and by reference number 905, the network node 110 may transmit, and the UE 120 may receive, an indication of a configuration for a first set of repetitions of a PUCCH transmitted via a first component carrier and a second set of repetitions of the PUCCH transmitted via the second component carrier. In some aspects, the network node 110 may transmit, and the UE 120 may receive, a media access control control element (MAC-CE) activating two sets of transmission parameters for PUCCH resources of one or more component carriers. For example, the MAC-CE may activate a first set of transmission parameters and a second set of transmission parameters for a first PUCCH resource of a first component carrier of a group of component carriers. In some aspects, the first set of transmission parameters associated with the first PUCCH resource may include first spatial relation information, a first uplink beam, and/or a first set of power control parameters. The second set of transmission parameters associated with the first PUCCH resource may include second spatial relation information, a second uplink beam, and/or a second set of power control parameters.

As another example, a MAC-CE may activate a third set of transmission parameters and a fourth set of transmission parameters for a second PUCCH resource of a second component carrier of the group of component carriers. In some aspects, the third set of transmission parameters associated with the second PUCCH resource may include third spatial relation information, a third uplink beam, and/or a third set of power control parameters. The fourth set of transmission parameters associated with the second PUCCH resource may include fourth spatial relation information, a fourth uplink beam, and/or a fourth set of power control parameters.

As shown by reference number 910, the UE 120 may determine one or more mapping patterns associated with transmitting the repetitions of the PUCCH. The mapping patterns may comprise a cyclic mapping pattern and/or a sequential mapping pattern. The cyclic mapping pattern may correspond to transmitting, via a component carrier, a first repetition of a PUCCH based at least in part on a first set of transmission parameters and a second repetition of the PUCCH based at least in part on a second set of transmission patterns. For example, a transmission of four repetitions of the PUCCH may include transmitting, via a component carrier, a first repetition of a PUCCH based at least in part on a first set of transmission parameters, transmitting a second repetition of the PUCCH based at least in part on a second set of transmission patterns, transmitting a third repetition of the PUCCH based at least in part on the first set of transmission patterns, and transmitting a fourth repetition of the PUCCH based at least in part on the second set of transmission patterns.

A transmission of four repetitions of the PUCCH according to a sequential mapping pattern may include transmitting, via a component carrier, a first repetition of the PUCCH based at least in part on a first set of transmission parameters, transmitting a second repetition of the PUCCH based at least in part on the first set of transmission patterns, transmitting a third repetition of the PUCCH based at least in part on a second set of transmission patterns, and transmitting a fourth repetition of the PUCCH based at least in part on the second set of transmission patterns.

In some aspects, the mapping pattern associated with a component carrier may be indicated by a configuration of the component carrier, a configuration of a PUCCH resource of the component carrier, or a format of the PUCCH resource of the component carrier.

In some aspects, the mapping pattern is separately applied to repetitions of the PUCCH transmitted via each component carrier. For example, a first mapping pattern associated with a first component carrier may be applied to repetitions of the PUCCH transmitted via the first component carrier and a second mapping pattern associated with a second component carrier may be applied to repetitions of the PUCCH transmitted via the second component carrier.

In some aspects, the second mapping pattern may be the same as the first mapping pattern. For example, the first mapping pattern and the second mapping pattern may both comprise a cyclic mapping pattern or may both comprise a sequential mapping pattern.

In some aspects, the second mapping pattern may be different from the first mapping pattern. For example, the first mapping pattern may comprise a cyclic mapping pattern and the second mapping pattern may comprise a sequential mapping pattern. As another example, the first mapping pattern may comprise a sequential mapping pattern and the second mapping pattern may comprise a cyclic mapping pattern.

In some aspects, the mapping pattern associated with a component carrier may indicate the mapping pattern for a group of component carriers. For example, a component carrier, of a group of component carriers, may be a reference component carrier (e.g., based at least in part on the component carrier having a smallest component carrier index relative to the component carrier indexes of other component carriers of the group of component carriers). A mapping pattern associated with the first component carrier may be applied to transmissions of repetitions of the PUCCH on all of the component carriers of the group of component carriers based at least in part on the first component carrier being the reference component carrier.

As shown by reference number 915, the UE 120 may transmit, and the network node 110 may receive, the first set of repetitions of the PUCCH and the second set of repetitions of the PUCCH in accordance with the configuration. In some aspects, at least one of the first set of repetitions of the PUCCH or the second set of repetitions of the PUCCH may be transmitted with multiple transmission parameters at different slots or at different sub-slots, as described elsewhere herein.

As indicated above, FIG. 9 is provided as an example. Other examples may differ from what is described with respect to FIG. 9.

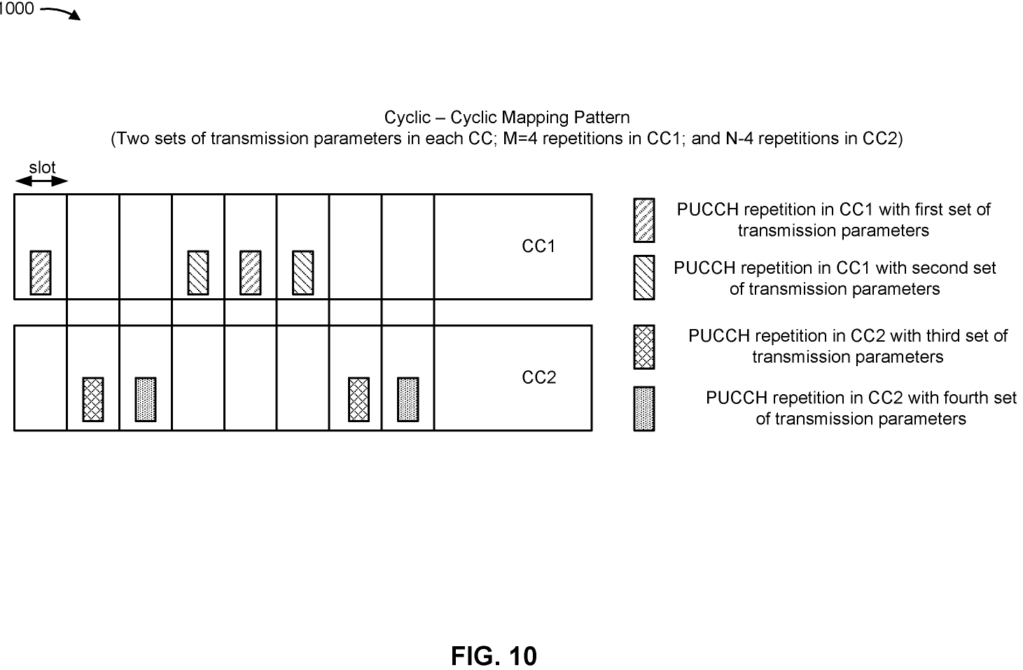

FIGS. 10-12 are diagrams illustrating examples 1000, 1100, and 1200, respectively, associated with performing multi-beam transmissions for PUCCH repetition across multiple component carriers, in accordance with the present disclosure.

In some aspects, as shown in FIG. 10, the configuration may indicate that mapping patterns for multi-beam transmissions for the repetitions of the PUCCH are to be performed separately across repetitions transmitted via a first component carrier and across repetitions transmitted across a second component carrier. For example, as shown in FIG. 10, the configuration may indicate that a cyclic mapping pattern is to be applied to a transmission of M repetitions of the PUCCH transmitted via the first component carrier CC1 and to a transmission of N repetitions of the PUCCH transmitted via the second component carrier CC2.

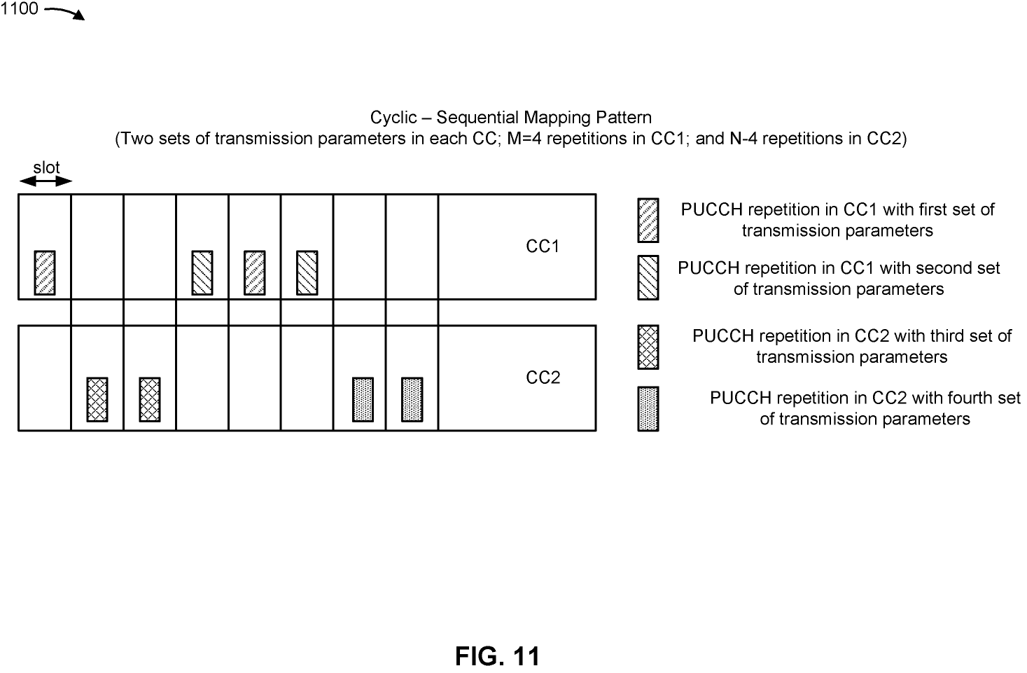

As another example, as shown in FIG. 11, the configuration may indicate that a cyclic mapping pattern is to be applied to a transmission of M repetitions of the PUCCH transmitted via the first component carrier CC1 and that a sequential mapping pattern is to be applied to a transmission of N repetitions of the PUCCH transmitted via the second component carrier CC2.

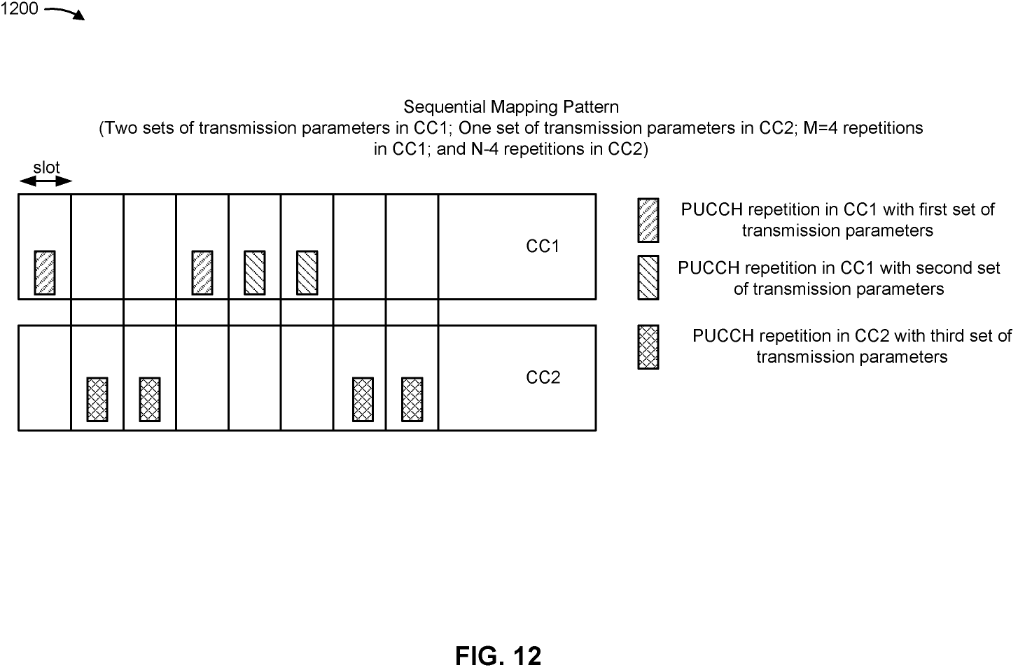

In some aspects, two sets of transmission parameters may be activated for one or more component carriers, of a group of component carriers, and a single set of transmission parameters may be activated for one or more other component carriers, of the group of component carriers. For example, as shown in FIG. 12, the configuration may indicate that a sequential mapping pattern is to be applied to a transmission of M repetitions of the PUCCH transmitted via the first component carrier CC1 based at least in part on two sets of transmission parameters being activated for the first component carrier. The configuration may indicate that a mapping pattern is not to be applied to a transmission of N repetitions of the PUCCH transmitted via the second component carrier CC2 based at least in part on a single set of transmission parameters being activated for the second component carrier CC2.

As indicated above, FIGS. 10-12 are provided as examples. Other examples may differ from what is described with respect to FIGS. 10-12.

FIG. 13 is a diagram illustrating an example process 1300 performed, for example, by a UE, in accordance with the present disclosure. Example process 1300 is an example where the UE (e.g., UE 120) performs operations associated with frequency hopping for physical uplink channel repetition across multiple component carriers.

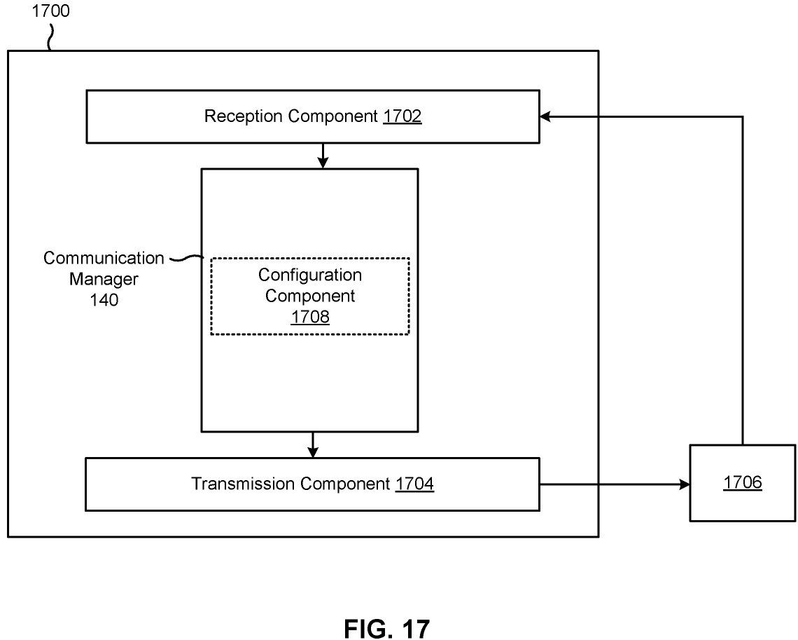

As shown in FIG. 13, in some aspects, process 1300 may include receiving an indication of a configuration for frequency hopping across repetitions of a PUCCH transmitted via a plurality of component carriers, wherein the plurality of component carriers includes at least a first component carrier and a second component carrier (block 1310). For example, the UE (e.g., using communication manager 140 and/or reception component 1702, depicted in FIG. 17) may receive an indication of a configuration for frequency hopping across repetitions of a PUCCH transmitted via a plurality of component carriers, wherein the plurality of component carriers includes at least a first component carrier and a second component carrier, as described above.

As further shown in FIG. 13, in some aspects, process 1300 may include transmitting the repetitions of the PUCCH in accordance with the configuration (block 1320). For example, the UE (e.g., using communication manager 140 and/or transmission component 1704, depicted in FIG. 17) may transmit the repetitions of the PUCCH in accordance with the configuration, as described above.

Process 1300 may include additional aspects, such as any single aspect or any combination of aspects described below and/or in connection with one or more other processes described elsewhere herein.

In a first aspect, the configuration indicates that the frequency hopping across the repetitions of the PUCCH transmitted via the plurality of component carriers includes inter-slot frequency hopping across the repetitions of the PUCCH transmitted via the plurality of component carriers.

In a second aspect, alone or in combination with the first aspect, the configuration indicates that the frequency hopping across the repetitions of the PUCCH transmitted via the plurality of component carriers includes inter-sub-slot frequency hopping across the repetitions of the PUCCH transmitted via the plurality of component carriers.

In a third aspect, alone or in combination with one or more of the first and second aspects, the configuration indicates that the frequency hopping across the repetitions of the PUCCH transmitted via the plurality of component carriers includes transmitting a first set of the repetitions of the PUCCH with frequency hopping across the first set of the repetitions of the PUCCH transmitted via the first component carrier and transmitting a second set of the repetitions of the PUCCH with frequency hopping across the second set of the repetitions of the PUCCH transmitted via the second component carrier.

In a fourth aspect, alone or in combination with one or more of the first through third aspects, the indication indicates a first PUCCH resource of the first component carrier and a second PUCCH resource of the second component carrier, wherein a configuration of the first PUCCH resource or a format associated with the first PUCCH resource indicates whether to perform frequency hopping across a first set of repetitions of the PUCCH transmitted via the first component carrier, and wherein a configuration of the second PUCCH resource or a format associated with the second PUCCH resource indicates whether to perform frequency hopping across a second set of repetitions of the PUCCH transmitted via the second component carrier.

In a fifth aspect, alone or in combination with one or more of the first through fourth aspects, the indication indicates a PUCCH resource of the first component carrier, wherein a configuration of the PUCCH resource indicates a first frequency hop and a second frequency hop for performing frequency hopping across a set of repetitions of the PUCCH transmitted via the first component carrier, and wherein even numbered repetitions of the set of repetitions of the PUCCH are transmitted in the first frequency hop and odd numbered repetitions of the set of repetitions of the PUCCH are transmitted in the second frequency hop.

In a sixth aspect, alone or in combination with one or more of the first through fifth aspects, the indication indicates a PUCCH resource of the second component carrier, wherein a configuration of the PUCCH resource indicates a first frequency hop and a second frequency hop for performing frequency hopping across a set of repetitions of the PUCCH transmitted via the second component carrier, and wherein even numbered repetitions of the set of repetitions of the PUCCH are transmitted in the first frequency hop and odd numbered repetitions of the set of repetitions of the PUCCH are transmitted in the second frequency hop.

In a seventh aspect, alone or in combination with one or more of the first through sixth aspects, the configuration indicates that the repetitions of the PUCCH are transmitted with frequency hopping across the repetitions in the first component carrier and the second component carrier, and even repetitions of the repetitions of the PUCCH are transmitted in a first frequency hop and odd numbered repetitions of the repetitions of the PUCCH are transmitted in a second frequency hop.

In an eighth aspect, alone or in combination with one or more of the first through seventh aspects, a location of the first frequency hop depends on whether a first repetition of the repetitions of the PUCCH is transmitted via the first component carrier or the second component carrier, and a location of the second frequency hop depends on whether a second repetition of the repetitions of the PUCCH is transmitted via the first component carrier or the second component carrier.

In a ninth aspect, alone or in combination with one or more of the first through eighth aspects, the indication indicates a first PUCCH resource associated with the first component carrier and a second PUCCH resource associated with the second component carrier, and the configuration indicates that the repetitions of the PUCCH are transmitted with frequency hopping across the repetitions in the first component carrier and the second component carrier based at least in part on a configuration of the first PUCCH resource or a format associated with the first PUCCH resource, and a configuration of the second PUCCH resource or a format associated with the second PUCCH resource.

In a tenth aspect, alone or in combination with one or more of the first through ninth aspects, the configuration indicates that the repetitions of the PUCCH are transmitted with frequency hopping across the repetitions in the first component carrier and the second component carrier when one or more of the configuration of the first PUCCH resource or the format associated with the first PUCCH resource indicates that the repetitions of the PUCCH are transmitted with frequency hopping across the repetitions in the first component carrier and the second component carrier, or the configuration of the second PUCCH resource or the format associated with the second PUCCH resource indicates that the repetitions of the PUCCH are transmitted with frequency hopping across the repetitions in the first component carrier and the second component carrier.

In an eleventh aspect, alone or in combination with one or more of the first through tenth aspects, one of the first component carrier or the second component carrier corresponds to a reference component carrier, and the configuration indicates that the repetitions of the PUCCH are transmitted with frequency hopping across the repetitions in the first component carrier and the second component carrier when a configuration of a PUCCH resource of the reference component carrier or a format associated with the PUCCH resource of the reference component carrier indicates that the repetitions of the PUCCH are transmitted with frequency hopping across the repetitions in the first component carrier and the second component carrier.

In a twelfth aspect, alone or in combination with one or more of the first through eleventh aspects, the first component carrier corresponds to the reference component carrier when a component carrier index associated with the first component carrier is lower than a component carrier index associated with the second component carrier.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., network node 110) performs operations associated with frequency hopping for physical uplink channel repetition across multiple component carriers.

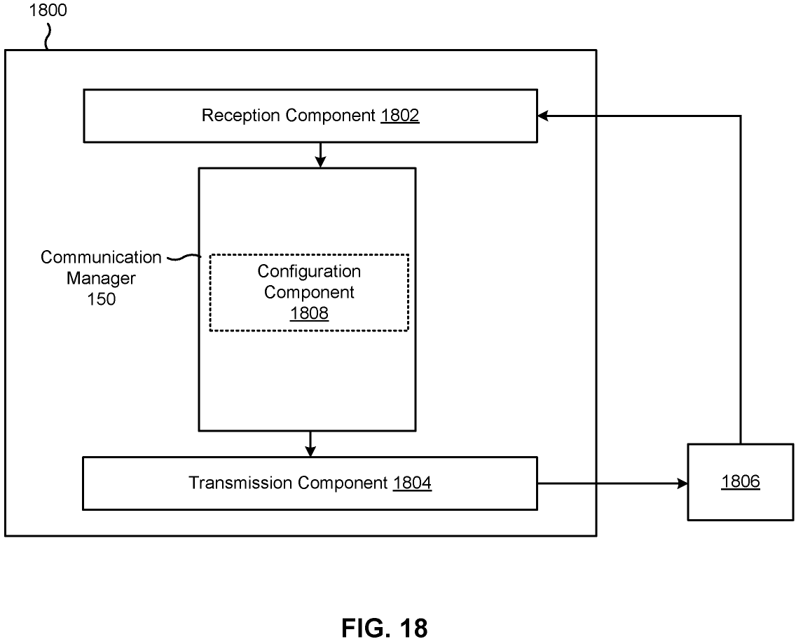

As shown in FIG. 14, in some aspects, process 1400 may include transmitting an indication of a configuration for frequency hopping across repetitions of a PUCCH transmitted via a plurality of component carriers, wherein the plurality of component carriers includes at least a first component carrier and a second component carrier (block 1410). For example, the network node (e.g., using communication manager 150 and/or transmission component 1804, depicted in FIG. 18) may transmit an indication of a configuration for frequency hopping across repetitions of a PUCCH transmitted via a plurality of component carriers, wherein the plurality of component carriers includes at least a first component carrier and a second component carrier, as described above.

As further shown in FIG. 14, in some aspects, process 1400 may include receiving the repetitions of the PUCCH in accordance with the configuration (block 1420). For example, the network node (e.g., using communication manager 150 and/or reception component 1802, depicted in FIG. 18) may receive the repetitions of the PUCCH in accordance with the configuration, as described above.

Process 1400 may include additional aspects, such as any single aspect or any combination of aspects described below and/or in connection with one or more other processes described elsewhere herein.

In a first aspect, the configuration indicates that the frequency hopping across the repetitions of the PUCCH transmitted via the plurality of component carriers includes inter-slot frequency hopping across the repetitions of the PUCCH transmitted via the plurality of component carriers.

In a second aspect, alone or in combination with the first aspect, the configuration indicates that the frequency hopping across the repetitions of the PUCCH transmitted via the plurality of component carriers includes inter-sub-slot frequency hopping across the repetitions of the PUCCH transmitted via the plurality of component carriers.

In a third aspect, alone or in combination with one or more of the first and second aspects, the configuration indicates that the frequency hopping across the repetitions of the PUCCH transmitted via the plurality of component carriers includes transmitting a first set of the repetitions of the PUCCH with frequency hopping across the first set of the repetitions of the PUCCH transmitted via the first component carrier and transmitting a second set of the repetitions of the PUCCH with frequency hopping across the second set of the repetitions of the PUCCH transmitted via the second component carrier.

In a fourth aspect, alone or in combination with one or more of the first through third aspects, the indication indicates a first PUCCH resource of the first component carrier and a second PUCCH resource of the second component carrier, wherein a configuration of the first PUCCH resource or a format associated with the first PUCCH resource indicates whether to perform frequency hopping across a first set of repetitions of the PUCCH transmitted via the first component carrier, and wherein a configuration of the second PUCCH resource or a format associated with the second PUCCH resource indicates whether to perform frequency hopping across a second set of repetitions of the PUCCH transmitted via the second component carrier.

In a fifth aspect, alone or in combination with one or more of the first through fourth aspects, the indication indicates a PUCCH resource of the first component carrier, wherein a configuration of the PUCCH resource indicates a first frequency hop and a second frequency hop for performing frequency hopping across a set of repetitions of the PUCCH transmitted via the first component carrier, and wherein even numbered repetitions of the set of repetitions of the PUCCH are transmitted in the first frequency hop and odd numbered repetitions of the set of repetitions of the PUCCH are transmitted in the second frequency hop.

In a sixth aspect, alone or in combination with one or more of the first through fifth aspects, the indication indicates a PUCCH resource of the second component carrier, wherein a configuration of the PUCCH resource indicates a first frequency hop and a second frequency hop for performing frequency hopping across a set of repetitions of the PUCCH transmitted via the second component carrier, and wherein even numbered repetitions of the set of repetitions of the PUCCH are transmitted in the first frequency hop and odd numbered repetitions of the set of repetitions of the PUCCH are transmitted in the second frequency hop.

In a seventh aspect, alone or in combination with one or more of the first through sixth aspects, the configuration indicates that the repetitions of the PUCCH are transmitted with frequency hopping across the repetitions in the first component carrier and the second component carrier, and even repetitions of the repetitions of the PUCCH are transmitted in a first frequency hop and odd numbered repetitions of the repetitions of the PUCCH are transmitted in a second frequency hop.

In an eighth aspect, alone or in combination with one or more of the first through seventh aspects, a location of the first frequency hop depends on whether a first repetition of the repetitions of the PUCCH is transmitted via the first component carrier or the second component carrier, and a location of the second frequency hop depends on whether a second repetition of the repetitions of the PUCCH is transmitted via the first component carrier or the second component carrier.

In a ninth aspect, alone or in combination with one or more of the first through eighth aspects, the indication indicates a first PUCCH resource associated with the first component carrier and a second PUCCH resource associated with the second component carrier, and the configuration indicates that the repetitions of the PUCCH are transmitted with frequency hopping across the repetitions in the first component carrier and the second component carrier based at least in part on a configuration of the first PUCCH resource or a format associated with the first PUCCH resource, and a configuration of the second PUCCH resource or a format associated with the second PUCCH resource.

In a tenth aspect, alone or in combination with one or more of the first through ninth aspects, the configuration indicates that the repetitions of the PUCCH are transmitted with frequency hopping across the repetitions in the first component carrier and the second component carrier when one or more of the configuration of the first PUCCH resource or the format associated with the first PUCCH resource indicates that the repetitions of the PUCCH are transmitted with frequency hopping across the repetitions in the first component carrier and the second component carrier, or the configuration of the second PUCCH resource or the format associated with the second PUCCH resource indicates that the repetitions of the PUCCH are transmitted with frequency hopping across the repetitions in the first component carrier and the second component carrier.

In an eleventh aspect, alone or in combination with one or more of the first through tenth aspects, one of the first component carrier or the second component carrier corresponds to a reference component carrier, and the configuration indicates that the repetitions of the PUCCH are transmitted with frequency hopping across the repetitions in the first component carrier and the second component carrier when a configuration of a PUCCH resource of the reference component carrier or a format associated with the PUCCH resource of the reference component carrier indicates that the repetitions of the PUCCH are transmitted with frequency hopping across the repetitions in the first component carrier and the second component carrier.

In a twelfth aspect, alone or in combination with one or more of the first through eleventh aspects, the first component carrier corresponds to the reference component carrier when a component carrier index associated with the first component carrier is lower than a component carrier index associated with the second component carrier.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by an UE, in accordance with the present disclosure. Example process 1500 is an example where the UE (e.g., UE 120) performs operations associated with multi-beam transmissions for physical uplink channel repetition across multiple component carriers.

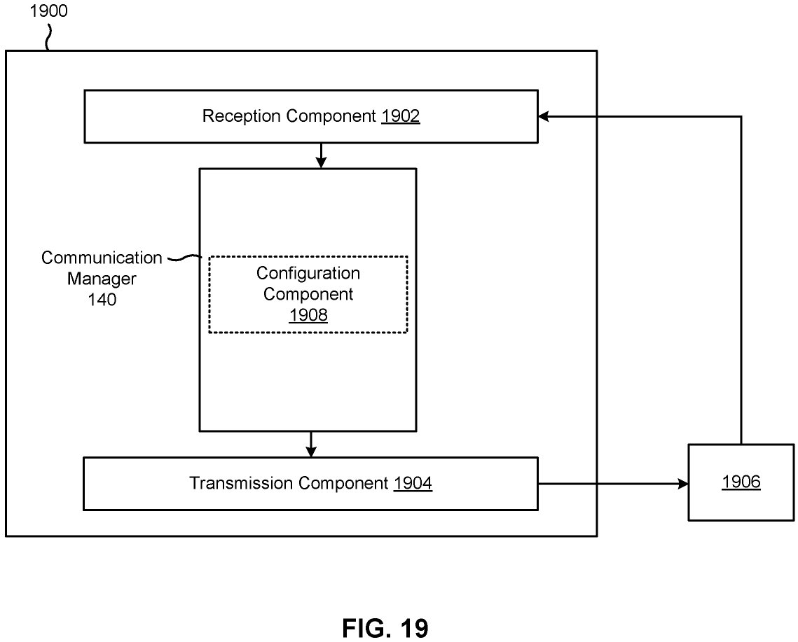

As shown in FIG. 15, in some aspects, process 1500 may include receiving an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters (block 1510). For example, the UE (e.g., using communication manager 140 and/or reception component 1902, depicted in FIG. 19) may receive an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters, as described above.

As further shown in FIG. 15, in some aspects, process 1500 may include transmitting the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots (block 1520). For example, the UE (e.g., using communication manager 140 and/or transmission component 1904, depicted in FIG. 19) may transmit the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots, as described above.

Process 1500 may include additional aspects, such as any single aspect or any combination of aspects described below and/or in connection with one or more other processes described elsewhere herein.

In a first aspect, the first set of transmission parameters includes one or more of first spatial relation information, a first uplink beam, or a first set of power control parameters, and the second set of transmission parameters includes one or more of second spatial relation information, a second uplink beam, or a second set of power control parameters.

In a second aspect, alone or in combination with the first aspect, process 1500 includes receiving a MAC-CE activating the first set of transmission parameters and the second set of transmission parameters for the at least one of the first PUCCH resource or the second PUCCH resource.

In a third aspect, alone or in combination with one or more of the first and second aspects, the first set of repetitions of the PUCCH is transmitted with the first set of transmission parameters and the second set of transmission parameters at different slots or at different sub-slots according to a first mapping pattern and the second set of repetitions of the PUCCH is transmitted with a third set of transmission parameters and a fourth set of transmission parameters at different slots or at different sub-slots according to a second mapping pattern when the first PUCCH resource is activated with the first set of transmission parameters and the second set of transmission parameters and the second PUCCH resource is activated with the third set of transmission parameters and the fourth set of transmission parameters, and the first mapping pattern and the second mapping pattern are separately applied to the first set of repetitions of the PUCCH and the second set of repetitions of the PUCCH, respectively.

In a fourth aspect, alone or in combination with one or more of the first through third aspects, a configuration of the first component carrier or a configuration of the first PUCCH resource or a format associated with the first PUCCH resource indicates the first mapping pattern, and a configuration of the second component carrier or a configuration of the second PUCCH resource or a format associated with the second PUCCH resource indicates the second mapping pattern.

In a fifth aspect, alone or in combination with one or more of the first through fourth aspects, the first mapping pattern comprises a cyclic mapping pattern and the second mapping pattern comprises the cyclic mapping pattern, the first mapping pattern comprises a cyclic mapping pattern and the second mapping pattern comprises to a sequential mapping pattern, the first mapping pattern comprises the sequential mapping pattern and the second mapping pattern comprises to the cyclic mapping pattern, or the first mapping pattern comprises the sequential mapping pattern and the second mapping pattern comprises to the sequential mapping pattern.

In a sixth aspect, alone or in combination with one or more of the first through fifth aspects, the first component carrier corresponds to a reference component carrier, wherein the first component carrier or the first PUCCH resource indicates a mapping pattern associated with transmitting the first set of repetitions of the PUCCH, wherein when the first PUCCH resource is activated with the first transmission parameters and the second transmission patterns, wherein the second PUCCH resource is activated with third transmission parameters and fourth transmission parameters, wherein the first set of repetitions of the PUCCH are transmitted with the first set of transmission parameters and the second set of transmission parameters at different slots or at different sub-slots according to the mapping pattern based at least in part on the first component carrier corresponding to the reference component carrier, and wherein the second set of repetitions of the PUCCH are transmitted with the third set of transmission parameters and the fourth set of transmission parameters at different slots or at different sub-slots according to the mapping pattern based at least in part on the first component carrier corresponding to the reference component carrier.

In a seventh aspect, alone or in combination with one or more of the first through sixth aspects, the mapping pattern comprises a cyclic mapping pattern or a sequential mapping pattern.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a network node, in accordance with the present disclosure. Example process 1600 is an example where the network node (e.g., network node 110) performs operations associated with multi-beam transmissions for physical uplink channel repetition across multiple component carriers.

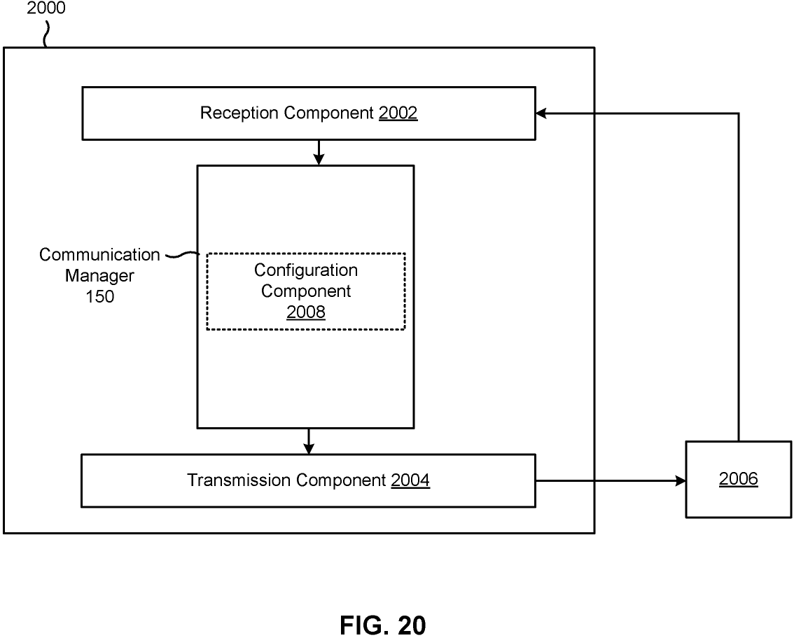

As shown in FIG. 16, in some aspects, process 1600 may include transmitting an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters (block 1610). For example, the network node (e.g., using communication manager 150 and/or transmission component 2004, depicted in FIG. 20) may transmit an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters, as described above.

As further shown in FIG. 16, in some aspects, process 1600 may include receiving the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots (block 1620). For example, the network node (e.g., using communication manager 150 and/or reception component 2002, depicted in FIG. 20) may receive the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots, as described above.

Process 1600 may include additional aspects, such as any single aspect or any combination of aspects described below and/or in connection with one or more other processes described elsewhere herein.

In a first aspect, the first set of transmission parameters includes one or more of first spatial relation information, a first uplink beam, or a first set of power control parameters, and the second set of transmission parameters includes one or more of second spatial relation information, a second uplink beam, or a second set of power control parameters.

In a second aspect, alone or in combination with the first aspect, process 1600 includes transmitting a MAC-CE activating the first set of transmission parameters and the second set of transmission parameters for the at least one of the first PUCCH resource or the second PUCCH resource.

In a third aspect, alone or in combination with one or more of the first and second aspects, the first set of repetitions of the PUCCH is transmitted with the first set of transmission parameters and the second set of transmission parameters at different slots or at different sub-slots according to a first mapping pattern and the second set of repetitions of the PUCCH is transmitted with a third set of transmission parameters and a fourth set of transmission parameters at different slots or at different sub-slots according to a second mapping pattern when the first PUCCH resource is activated with the first set of transmission parameters and the second set of transmission parameters and the second PUCCH resource is activated with the third set of transmission parameters and the fourth set of transmission parameters, and the first mapping pattern and the second mapping pattern are separately applied to the first set of repetitions of the PUCCH and the second set of repetitions of the PUCCH, respectively.

In a fourth aspect, alone or in combination with one or more of the first through third aspects, a configuration of the first component carrier or a configuration of the first PUCCH resource or a format associated with the first PUCCH resource indicates the first mapping pattern, and a configuration of the second component carrier or a configuration of the second PUCCH resource or a format associated with the second PUCCH resource indicates the second mapping pattern.

In a fifth aspect, alone or in combination with one or more of the first through fourth aspects, the first mapping pattern comprises a cyclic mapping pattern and the second mapping pattern comprises the cyclic mapping pattern, the first mapping pattern comprises a cyclic mapping pattern and the second mapping pattern comprises to a sequential mapping pattern, the first mapping pattern comprises the sequential mapping pattern and the second mapping pattern comprises to the cyclic mapping pattern, or the first mapping pattern comprises the sequential mapping pattern and the second mapping pattern comprises to the sequential mapping pattern.

In a sixth aspect, alone or in combination with one or more of the first through fifth aspects, the first component carrier corresponds to a reference component carrier, wherein the first component carrier or the first PUCCH resource indicates a mapping pattern associated with transmitting the first set of repetitions of the PUCCH, wherein when the first PUCCH resource is activated with the first transmission parameters and the second transmission patterns, wherein the second PUCCH resource is activated with third transmission parameters and fourth transmission parameters, wherein the first set of repetitions of the PUCCH are transmitted with the first set of transmission parameters and the second set of transmission parameters at different slots or at different sub-slots according to the mapping pattern based at least in part on the first component carrier corresponding to the reference component carrier, and wherein the second set of repetitions of the PUCCH are transmitted with the third set of transmission parameters and the fourth set of transmission parameters at different slots or at different sub-slots according to the mapping pattern based at least in part on the first component carrier corresponding to the reference component carrier.

In a seventh aspect, alone or in combination with one or more of the first through sixth aspects, the mapping pattern comprises a cyclic mapping pattern or a sequential mapping pattern.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram of an example apparatus 1700 for wireless communication. The apparatus 1700 may be a UE, or a UE may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a network node, or another wireless communication device) using the reception component 1702 and the transmission component 1704. As further shown, the apparatus 1700 may include the communication manager 140. The communication manager 140 may include a configuration component 1708, among other examples.

In some aspects, the apparatus 1700 may be configured to perform one or more operations described herein in connection with FIGS. 5-12. Additionally, or alternatively, the apparatus 1700 may be configured to perform one or more processes described herein, such as process 1300 of FIG. 13, process 1500 of FIG. 15, or a combination thereof. In some aspects, the apparatus 1700 and/or one or more components shown in FIG. 17 may include one or more components of the UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the UE described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the UE described in connection with FIG. 2. In some aspects, the transmission component 1704 may be co-located with the reception component 1702 in a transceiver.

The reception component 1702 may receive an indication of a configuration for frequency hopping across repetitions of a PUCCH transmitted via a plurality of component carriers, wherein the plurality of component carriers includes at least a first component carrier and a second component carrier. The configuration component 1708 may determine a first frequency hop and a second frequency hop associated with performing the frequency hopping across repetitions of the PUCCH. The transmission component 1704 may transmit the repetitions of the PUCCH in accordance with the configuration.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication. The apparatus 1800 may be a network node, or a network node may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a network node, or another wireless communication device) using the reception component 1802 and the transmission component 1804. As further shown, the apparatus 1800 may include the communication manager 150. The communication manager 150 may include a configuration component 1808, among other examples.

In some aspects, the apparatus 1800 may be configured to perform one or more operations described herein in connection with FIGS. 5-12. Additionally, or alternatively, the apparatus 1800 may be configured to perform one or more processes described herein, such as process 1400 of FIG. 14, process 1600 of FIG. 16, or a combination thereof. In some aspects, the apparatus 1800 and/or one or more components shown in FIG. 18 may include one or more components of the network node described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the network node described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the network node described in connection with FIG. 2. In some aspects, the transmission component 1804 may be co-located with the reception component 1802 in a transceiver.

The transmission component 1804 may transmit an indication of a configuration (e.g., a configuration generated by the configuration component 1808) for frequency hopping across repetitions of a PUCCH transmitted via a plurality of component carriers, wherein the plurality of component carriers includes at least a first component carrier and a second component carrier. The reception component 1802 may receive the repetitions of the PUCCH in accordance with the configuration.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

FIG. 19 is a diagram of an example apparatus 1900 for wireless communication. The apparatus 1900 may be a UE, or a UE may include the apparatus 1900. In some aspects, the apparatus 1900 includes a reception component 1902 and a transmission component 1904, which may be in communication with one another (for example, via one or more buses and/or one or more other components). As shown, the apparatus 1900 may communicate with another apparatus 1906 (such as a UE, a network node, or another wireless communication device) using the reception component 1902 and the transmission component 1904. As further shown, the apparatus 1900 may include the communication manager 140. The communication manager 140 may include a configuration component 1908, among other examples.

In some aspects, the apparatus 1900 may be configured to perform one or more operations described herein in connection with FIGS. 5-12. Additionally, or alternatively, the apparatus 1900 may be configured to perform one or more processes described herein, such as process 1300 of FIG. 13, process 1500 of FIG. 15, or a combination thereof. In some aspects, the apparatus 1900 and/or one or more components shown in FIG. 19 may include one or more components of the UE described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1902 may receive communications, such as reference signals, control information, data communications, or a combination thereof, from the apparatus 1906. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, a modem, a demodulator, a MIMO detector, a receive processor, a controller/processor, a memory, or a combination thereof, of the UE described in connection with FIG. 2.

The transmission component 1904 may transmit communications, such as reference signals, control information, data communications, or a combination thereof, to the apparatus 1906. In some aspects, one or more other components of the apparatus 1900 may generate communications and may provide the generated communications to the transmission component 1904 for transmission to the apparatus 1906. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1906. In some aspects, the transmission component 1904 may include one or more antennas, a modem, a modulator, a transmit MIMO processor, a transmit processor, a controller/processor, a memory, or a combination thereof, of the UE described in connection with FIG. 2. In some aspects, the transmission component 1904 may be co-located with the reception component 1902 in a transceiver.

The reception component 1902 may receive an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters. The configuration component 1908 may determine a quantity of repetitions associated with the first set of repetitions of the PUCCH and/or a quantity of repetitions associated with the second set of repetitions of the PUCCH. The transmission component 1904 may transmit the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots.

The reception component 1902 may receive a MAC-CE activating the first set of transmission parameters and the second set of transmission parameters for the at least one of the first PUCCH resource or the second PUCCH resource.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

FIG. 20 is a diagram of an example apparatus 2000 for wireless communication. The apparatus 2000 may be a network node, or a network node may include the apparatus 2000. In some aspects, the apparatus 2000 includes a reception component 2002 and a transmission component 2004, which may be in communication with one another (for example, via one or more buses and/or one or more other components). As shown, the apparatus 2000 may communicate with another apparatus 2006 (such as a UE, a network node, or another wireless communication device) using the reception component 2002 and the transmission component 2004. As further shown, the apparatus 2000 may include the communication manager 150. The communication manager 150 may include a configuration component 2008, among other examples.

In some aspects, the apparatus 2000 may be configured to perform one or more operations described herein in connection with FIGS. 5-12. Additionally, or alternatively, the apparatus 2000 may be configured to perform one or more processes described herein, such as process 1400 of FIG. 14, process 1600 of FIG. 16, or a combination thereof. In some aspects, the apparatus 2000 and/or one or more components shown in FIG. 20 may include one or more components of the network node described in connection with FIG. 2. Additionally, or alternatively, one or more components shown in FIG. 20 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2002 may receive communications, such as reference signals, control information, data communications, or a combination thereof, from the apparatus 2006. The reception component 2002 may provide received communications to one or more other components of the apparatus 2000. In some aspects, the reception component 2002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2000. In some aspects, the reception component 2002 may include one or more antennas, a modem, a demodulator, a MIMO detector, a receive processor, a controller/processor, a memory, or a combination thereof, of the network node described in connection with FIG. 2.

The transmission component 2004 may transmit communications, such as reference signals, control information, data communications, or a combination thereof, to the apparatus 2006. In some aspects, one or more other components of the apparatus 2000 may generate communications and may provide the generated communications to the transmission component 2004 for transmission to the apparatus 2006. In some aspects, the transmission component 2004 may perform signal processing on the generated communications (such as filtering, amplification, modulation, digital-to-analog conversion, multiplexing, interleaving, mapping, or encoding, among other examples), and may transmit the processed signals to the apparatus 2006. In some aspects, the transmission component 2004 may include one or more antennas, a modem, a modulator, a transmit MIMO processor, a transmit processor, a controller/processor, a memory, or a combination thereof, of the network node described in connection with FIG. 2. In some aspects, the transmission component 2004 may be co-located with the reception component 2002 in a transceiver.

The transmission component 2004 may transmit an indication of a configuration (e.g., a configuration generated by the configuration component 2008) for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters. The reception component 2002 may receive the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots.

The transmission component 2004 may transmit a MAC-CE activating the first set of transmission parameters and the second set of transmission parameters for the at least one of the first PUCCH resource or the second PUCCH resource.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

The following provides an overview of some Aspects of the present disclosure:
Aspect 1: A method of wireless communication performed by a UE, comprising: receiving an indication of a configuration for frequency hopping across repetitions of a PUCCH transmitted via a plurality of component carriers, wherein the plurality of component carriers includes at least a first component carrier and a second component carrier; and transmitting the repetitions of the PUCCH in accordance with the configuration.
Aspect 2: The method of Aspect 1, wherein the configuration indicates that the frequency hopping across the repetitions of the PUCCH transmitted via the plurality of component carriers includes inter-slot frequency hopping across the repetitions of the PUCCH transmitted via the plurality of component carriers.
Aspect 3: The method of one or more of Aspects 1 and 2, wherein the configuration indicates that the frequency hopping across the repetitions of the PUCCH transmitted via the plurality of component carriers includes inter-sub-slot frequency hopping across the repetitions of the PUCCH transmitted via the plurality of component carriers.
Aspect 4: The method of one or more of Aspects 1 through 3, wherein the configuration indicates that the frequency hopping across the repetitions of the PUCCH transmitted via the plurality of component carriers includes transmitting a first set of the repetitions of the PUCCH with frequency hopping across the first set of the repetitions of the PUCCH transmitted via the first component carrier and transmitting a second set of the repetitions of the PUCCH with frequency hopping across the second set of the repetitions of the PUCCH transmitted via the second component carrier.
Aspect 5: The method of one or more of Aspects 1 through 4, wherein the indication indicates a first PUCCH resource of the first component carrier and a second PUCCH resource of the second component carrier, wherein a configuration of the first PUCCH resource or a format associated with the first PUCCH resource indicates whether to perform frequency hopping across a first set of repetitions of the PUCCH transmitted via the first component carrier, and wherein a configuration of the second PUCCH resource or a format associated with the second PUCCH resource indicates whether to perform frequency hopping across a second set of repetitions of the PUCCH transmitted via the second component carrier.
Aspect 6: The method of one or more of Aspects 1 through 5, wherein the indication indicates a PUCCH resource of the first component carrier, wherein a configuration of the PUCCH resource indicates a first frequency hop and a second frequency hop for performing frequency hopping across a set of repetitions of the PUCCH transmitted via the first component carrier, and wherein even numbered repetitions of the set of repetitions of the PUCCH are transmitted in the first frequency hop and odd numbered repetitions of the set of repetitions of the PUCCH are transmitted in the second frequency hop.
Aspect 7: The method of one or more of Aspects 1 through 6, wherein the indication indicates a PUCCH resource of the second component carrier, wherein a configuration of the PUCCH resource indicates a first frequency hop and a second frequency hop for performing frequency hopping across a set of repetitions of the PUCCH transmitted via the second component carrier, and wherein even numbered repetitions of the set of repetitions of the PUCCH are transmitted in the first frequency hop and odd numbered repetitions of the set of repetitions of the PUCCH are transmitted in the second frequency hop.
Aspect 8: The method of one or more of Aspects 1 through 7, wherein the configuration indicates that the repetitions of the PUCCH are transmitted with frequency hopping across the repetitions in the first component carrier and the second component carrier, and wherein even repetitions of the repetitions of the PUCCH are transmitted in a first frequency hop and odd numbered repetitions of the repetitions of the PUCCH are transmitted in a second frequency hop.
Aspect 9: The method of Aspect 8, wherein a location of the first frequency hop depends on whether a first repetition of the repetitions of the PUCCH is transmitted via the first component carrier or the second component carrier, and wherein a location of the second frequency hop depends on whether a second repetition of the repetitions of the PUCCH is transmitted via the first component carrier or the second component carrier.
Aspect 10: The method of Aspect 8, wherein the indication indicates a first PUCCH resource associated with the first component carrier and a second PUCCH resource associated with the second component carrier, and wherein the configuration indicates that the repetitions of the PUCCH are transmitted with frequency hopping across the repetitions in the first component carrier and the second component carrier based at least in part on: a configuration of the first PUCCH resource or a format associated with the first PUCCH resource, and a configuration of the second PUCCH resource or a format associated with the second PUCCH resource.
Aspect 11: The method of Aspect 10, wherein the configuration indicates that the repetitions of the PUCCH are transmitted with frequency hopping across the repetitions in the first component carrier and the second component carrier when one or more of: the configuration of the first PUCCH resource or the format associated with the first PUCCH resource indicates that the repetitions of the PUCCH are transmitted with frequency hopping across the repetitions in the first component carrier and the second component carrier, or the configuration of the second PUCCH resource or the format associated with the second PUCCH resource indicates that the repetitions of the PUCCH are transmitted with frequency hopping across the repetitions in the first component carrier and the second component carrier.
Aspect 12: The method of Aspect 10, wherein one of the first component carrier or the second component carrier corresponds to a reference component carrier, and wherein the configuration indicates that the repetitions of the PUCCH are transmitted with frequency hopping across the repetitions in the first component carrier and the second component carrier when a configuration of a PUCCH resource of the reference component carrier or a format associated with the PUCCH resource of the reference component carrier indicates that the repetitions of the PUCCH are transmitted with frequency hopping across the repetitions in the first component carrier and the second component carrier.
Aspect 13: The method of Aspect 12, wherein the first component carrier corresponds to the reference component carrier when a component carrier index associated with the first component carrier is lower than a component carrier index associated with the second component carrier.
Aspect 14: A method of wireless communication performed by a network node, comprising: transmitting an indication of a configuration for frequency hopping across repetitions of a PUCCH transmitted via a plurality of component carriers, wherein the plurality of component carriers includes at least a first component carrier and a second component carrier; and receiving the repetitions of the PUCCH in accordance with the configuration.
Aspect 15: The method of Aspect 14, wherein the configuration indicates that the frequency hopping across the repetitions of the PUCCH transmitted via the plurality of component carriers includes inter-slot frequency hopping across the repetitions of the PUCCH transmitted via the plurality of component carriers.
Aspect 16: The method of one or more of Aspects 14 and 15, wherein the configuration indicates that the frequency hopping across the repetitions of the PUCCH transmitted via the plurality of component carriers includes inter-sub-slot frequency hopping across the repetitions of the PUCCH transmitted via the plurality of component carriers.
Aspect 17: The method of one or more of Aspects 14 through 16, wherein the configuration indicates that the frequency hopping across the repetitions of the PUCCH transmitted via the plurality of component carriers includes transmitting a first set of the repetitions of the PUCCH with frequency hopping across the first set of the repetitions of the PUCCH transmitted via the first component carrier and transmitting a second set of the repetitions of the PUCCH with frequency hopping across the second set of the repetitions of the PUCCH transmitted via the second component carrier.
Aspect 18: The method of one or more of Aspects 14 through 17, wherein the indication indicates a first PUCCH resource of the first component carrier and a second PUCCH resource of the second component carrier, wherein a configuration of the first PUCCH resource or a format associated with the first PUCCH resource indicates whether to perform frequency hopping across a first set of repetitions of the PUCCH transmitted via the first component carrier, and wherein a configuration of the second PUCCH resource or a format associated with the second PUCCH resource indicates whether to perform frequency hopping across a second set of repetitions of the PUCCH transmitted via the second component carrier.
Aspect 19: The method of one or more of Aspects 14 through 18, wherein the indication indicates a PUCCH resource of the first component carrier, wherein a configuration of the PUCCH resource indicates a first frequency hop and a second frequency hop for performing frequency hopping across a set of repetitions of the PUCCH transmitted via the first component carrier, and wherein even numbered repetitions of the set of repetitions of the PUCCH are transmitted in the first frequency hop and odd numbered repetitions of the set of repetitions of the PUCCH are transmitted in the second frequency hop.
Aspect 20: The method of one or more of Aspects 14 through 19, wherein the indication indicates a PUCCH resource of the second component carrier, wherein a configuration of the PUCCH resource indicates a first frequency hop and a second frequency hop for performing frequency hopping across a set of repetitions of the PUCCH transmitted via the second component carrier, and wherein even numbered repetitions of the set of repetitions of the PUCCH are transmitted in the first frequency hop and odd numbered repetitions of the set of repetitions of the PUCCH are transmitted in the second frequency hop.
Aspect 21: The method of one or more of Aspects 14 through 20, wherein the configuration indicates that the repetitions of the PUCCH are transmitted with frequency hopping across the repetitions in the first component carrier and the second component carrier, and wherein even repetitions of the repetitions of the PUCCH are transmitted in a first frequency hop and odd numbered repetitions of the repetitions of the PUCCH are transmitted in a second frequency hop.
Aspect 22: The method of Aspect 21, wherein a location of the first frequency hop depends on whether a first repetition of the repetitions of the PUCCH is transmitted via the first component carrier or the second component carrier, and wherein a location of the second frequency hop depends on whether a second repetition of the repetitions of the PUCCH is transmitted via the first component carrier or the second component carrier.
Aspect 23: The method of Aspect 21, wherein the indication indicates a first PUCCH resource associated with the first component carrier and a second PUCCH resource associated with the second component carrier, and wherein the configuration indicates that the repetitions of the PUCCH are transmitted with frequency hopping across the repetitions in the first component carrier and the second component carrier based at least in part on: a configuration of the first PUCCH resource or a format associated with the first PUCCH resource, and a configuration of the second PUCCH resource or a format associated with the second PUCCH resource.
Aspect 24: The method of Aspect 23, wherein the configuration indicates that the repetitions of the PUCCH are transmitted with frequency hopping across the repetitions in the first component carrier and the second component carrier when one or more of: the configuration of the first PUCCH resource or the format associated with the first PUCCH resource indicates that the repetitions of the PUCCH are transmitted with frequency hopping across the repetitions in the first component carrier and the second component carrier, or the configuration of the second PUCCH resource or the format associated with the second PUCCH resource indicates that the repetitions of the PUCCH are transmitted with frequency hopping across the repetitions in the first component carrier and the second component carrier.
Aspect 25: The method of Aspect 23, wherein one of the first component carrier or the second component carrier corresponds to a reference component carrier, and wherein the configuration indicates that the repetitions of the PUCCH are transmitted with frequency hopping across the repetitions in the first component carrier and the second component carrier when a configuration of a PUCCH resource of the reference component carrier or a format associated with the PUCCH resource of the reference component carrier indicates that the repetitions of the PUCCH are transmitted with frequency hopping across the repetitions in the first component carrier and the second component carrier.
Aspect 26: The method of Aspect 25, wherein the first component carrier corresponds to the reference component carrier when a component carrier index associated with the first component carrier is lower than a component carrier index associated with the second component carrier.
Aspect 27: A method of wireless communication performed by a UE, comprising: receiving an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters; and transmitting the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots.
Aspect 28: The method of Aspect 27, wherein the first set of transmission parameters includes one or more of first spatial relation information, a first uplink beam, or a first set of power control parameters, and wherein the second set of transmission parameters includes one or more of second spatial relation information, a second uplink beam, or a second set of power control parameters.
Aspect 29: The method of one or more of Aspects 27 and 28, further comprising: receiving a MAC-CE activating the first set of transmission parameters and the second set of transmission parameters for the at least one of the first PUCCH resource or the second PUCCH resource.
Aspect 30: The method of one or more of Aspects 27 through 29, wherein the first set of repetitions of the PUCCH is transmitted with the first set of transmission parameters and the second set of transmission parameters at different slots or at different sub-slots according to a first mapping pattern and the second set of repetitions of the PUCCH is transmitted with a third set of transmission parameters and a fourth set of transmission parameters at different slots or at different sub-slots according to a second mapping pattern when the first PUCCH resource is activated with the first set of transmission parameters and the second set of transmission parameters and the second PUCCH resource is activated with the third set of transmission parameters and the fourth set of transmission parameters, and wherein the first mapping pattern and the second mapping pattern are separately applied to the first set of repetitions of the PUCCH and the second set of repetitions of the PUCCH, respectively.
Aspect 31: The method of one or more of Aspects 27 through 30, wherein a configuration of the first component carrier or a configuration of the first PUCCH resource or a format associated with the first PUCCH resource indicates the first mapping pattern, and wherein a configuration of the second component carrier or a configuration of the second PUCCH resource or a format associated with the second PUCCH resource indicates the second mapping pattern.
Aspect 32: The method of one or more of Aspects 27 through 31, wherein: the first mapping pattern comprises a cyclic mapping pattern and the second mapping pattern comprises the cyclic mapping pattern, the first mapping pattern comprises a cyclic mapping pattern and the second mapping pattern comprises to a sequential mapping pattern, the first mapping pattern comprises the sequential mapping pattern and the second mapping pattern comprises to the cyclic mapping pattern, or the first mapping pattern comprises the sequential mapping pattern and the second mapping pattern comprises to the sequential mapping pattern.
Aspect 33: The method of one or more of Aspects 27 through 32, wherein the first component carrier corresponds to a reference component carrier, wherein the first component carrier or the first PUCCH resource indicates a mapping pattern associated with transmitting the first set of repetitions of the PUCCH, wherein when the first PUCCH resource is activated with the first transmission parameters and the second transmission patterns, wherein the second PUCCH resource is activated with third transmission parameters and fourth transmission parameters, wherein the first set of repetitions of the PUCCH are transmitted with the first set of transmission parameters and the second set of transmission parameters at different slots or at different sub-slots according to the mapping pattern based at least in part on the first component carrier corresponding to the reference component carrier, and wherein the second set of repetitions of the PUCCH are transmitted with the third set of transmission parameters and the fourth set of transmission parameters at different slots or at different sub-slots according to the mapping pattern based at least in part on the first component carrier corresponding to the reference component carrier.
Aspect 34: The method of Aspect 33, wherein the mapping pattern comprises a cyclic mapping pattern or a sequential mapping pattern.
Aspect 35: A method of wireless communication performed by a network node, comprising: transmitting an indication of a configuration for a first set of repetitions of a PUCCH transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters; and receiving the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots.
Aspect 36: The method of Aspect 35, wherein the first set of transmission parameters includes one or more of first spatial relation information, a first uplink beam, or a first set of power control parameters, and wherein the second set of transmission parameters includes one or more of second spatial relation information, a second uplink beam, or a second set of power control parameters.
Aspect 37: The method of one or more of Aspects 35 and 36, further comprising: transmitting a MAC-CE activating the first set of transmission parameters and the second set of transmission parameters for the at least one of the first PUCCH resource or the second PUCCH resource.
Aspect 38: The method of one or more of Aspects 35 through 37, wherein the first set of repetitions of the PUCCH is transmitted with the first set of transmission parameters and the second set of transmission parameters at different slots or at different sub-slots according to a first mapping pattern and the second set of repetitions of the PUCCH is transmitted with a third set of transmission parameters and a fourth set of transmission parameters at different slots or at different sub-slots according to a second mapping pattern when the first PUCCH resource is activated with the first set of transmission parameters and the second set of transmission parameters and the second PUCCH resource is activated with the third set of transmission parameters and the fourth set of transmission parameters, and wherein the first mapping pattern and the second mapping pattern are separately applied to the first set of repetitions of the PUCCH and the second set of repetitions of the PUCCH, respectively.
Aspect 39: The method of Aspect 38, wherein a configuration of the first component carrier or a configuration of the first PUCCH resource or a format associated with the first PUCCH resource indicates the first mapping pattern, and wherein a configuration of the second component carrier or a configuration of the second PUCCH resource or a format associated with the second PUCCH resource indicates the second mapping pattern.
Aspect 40: The method of Aspect 38, wherein: the first mapping pattern comprises a cyclic mapping pattern and the second mapping pattern comprises the cyclic mapping pattern, the first mapping pattern comprises a cyclic mapping pattern and the second mapping pattern comprises to a sequential mapping pattern, the first mapping pattern comprises the sequential mapping pattern and the second mapping pattern comprises to the cyclic mapping pattern, or the first mapping pattern comprises the sequential mapping pattern and the second mapping pattern comprises to the sequential mapping pattern.
Aspect 41: The method of one or more of Aspects 35 through 40, wherein the first component carrier corresponds to a reference component carrier, wherein the first component carrier or the first PUCCH resource indicates a mapping pattern associated with transmitting the first set of repetitions of the PUCCH, wherein when the first PUCCH resource is activated with the first transmission parameters and the second transmission patterns, wherein the second PUCCH resource is activated with third transmission parameters and fourth transmission parameters, wherein the first set of repetitions of the PUCCH are transmitted with the first set of transmission parameters and the second set of transmission parameters at different slots or at different sub-slots according to the mapping pattern based at least in part on the first component carrier corresponding to the reference component carrier, and wherein the second set of repetitions of the PUCCH are transmitted with the third set of transmission parameters and the fourth set of transmission parameters at different slots or at different sub-slots according to the mapping pattern based at least in part on the first component carrier corresponding to the reference component carrier.
Aspect 42: The method of Aspect 41, wherein the mapping pattern comprises a cyclic mapping pattern or a sequential mapping pattern.
Aspect 43: An apparatus for wireless communication at a device, comprising a processor; memory coupled with the processor; and instructions stored in the memory and executable by the processor to cause the apparatus to perform the method of one or more of Aspects 1 through 13.
Aspect 44: A device for wireless communication, comprising a memory and one or more processors coupled to the memory, the one or more processors configured to perform the method of one or more of Aspects 1 through 13.
Aspect 45: An apparatus for wireless communication, comprising at least one means for performing the method of one or more of Aspects 1 through 13.
Aspect 46: A non-transitory computer-readable medium storing code for wireless communication, the code comprising instructions executable by a processor to perform the method of one or more of Aspects 1 through 13.
Aspect 47: A non-transitory computer-readable medium storing a set of instructions for wireless communication, the set of instructions comprising one or more instructions that, when executed by one or more processors of a device, cause the device to perform the method of one or more of Aspects 1 through 13.
Aspect 48: An apparatus for wireless communication at a device, comprising a processor; memory coupled with the processor; and instructions stored in the memory and executable by the processor to cause the apparatus to perform the method of one or more of Aspects 14 through 26.
Aspect 49: A device for wireless communication, comprising a memory and one or more processors coupled to the memory, the one or more processors configured to perform the method of one or more of Aspects 14 through 26.
Aspect 50: An apparatus for wireless communication, comprising at least one means for performing the method of one or more of Aspects 14 through 26.
Aspect 51: A non-transitory computer-readable medium storing code for wireless communication, the code comprising instructions executable by a processor to perform the method of one or more of Aspects 14 through 26.
Aspect 52: A non-transitory computer-readable medium storing a set of instructions for wireless communication, the set of instructions comprising one or more instructions that, when executed by one or more processors of a device, cause the device to perform the method of one or more of Aspects 14 through 26.
Aspect 53: An apparatus for wireless communication at a device, comprising a processor; memory coupled with the processor; and instructions stored in the memory and executable by the processor to cause the apparatus to perform the method of one or more of Aspects 27 through 34.
Aspect 54: A device for wireless communication, comprising a memory and one or more processors coupled to the memory, the one or more processors configured to perform the method of one or more of Aspects 27 through 34.
Aspect 55: An apparatus for wireless communication, comprising at least one means for performing the method of one or more of Aspects 27 through 34.
Aspect 56: A non-transitory computer-readable medium storing code for wireless communication, the code comprising instructions executable by a processor to perform the method of one or more of Aspects 27 through 34.
Aspect 57: A non-transitory computer-readable medium storing a set of instructions for wireless communication, the set of instructions comprising one or more instructions that, when executed by one or more processors of a device, cause the device to perform the method of one or more of Aspects 27 through 34.
Aspect 58: An apparatus for wireless communication at a device, comprising a processor; memory coupled with the processor; and instructions stored in the memory and executable by the processor to cause the apparatus to perform the method of one or more of Aspects 35 through 42.
Aspect 59: A device for wireless communication, comprising a memory and one or more processors coupled to the memory, the one or more processors configured to perform the method of one or more of Aspects 35 through 42.
Aspect 60: An apparatus for wireless communication, comprising at least one means for performing the method of one or more of Aspects 35 through 42.
Aspect 61: A non-transitory computer-readable medium storing code for wireless communication, the code comprising instructions executable by a processor to perform the method of one or more of Aspects 35 through 42.
Aspect 62: A non-transitory computer-readable medium storing a set of instructions for wireless communication, the set of instructions comprising one or more instructions that, when executed by one or more processors of a device, cause the device to perform the method of one or more of Aspects 35 through 42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b+b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles "a" and "an" are intended to include one or more items and may be used interchangeably with "one or more." Further, as used herein, the article "the" is intended to include one or more items referenced in connection with the article "the" and may be used interchangeably with "the one or more." Furthermore, as used herein, the terms "set" and "group" are intended to include one or more items and may be used interchangeably with "one or more." Where only one item is intended, the phrase "only one" or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive an indication of a configuration for frequency hopping across repetitions of a physical uplink control channel (PUCCH) transmitted via a plurality of component carriers, wherein the plurality of component carriers includes at least a first component carrier and a second component carrier; and
transmit the repetitions of the PUCCH in accordance with the configuration.

2. The UE of claim 1, wherein the configuration indicates that the frequency hopping across the repetitions of the PUCCH transmitted via the plurality of component carriers includes inter-slot frequency hopping across the repetitions of the PUCCH transmitted via the plurality of component carriers.

3. The UE of claim 1, wherein the configuration indicates that the frequency hopping across the repetitions of the PUCCH transmitted via the plurality of component carriers includes inter-sub-slot frequency hopping across the repetitions of the PUCCH transmitted via the plurality of component carriers.

4. The UE of claim 1, wherein the configuration indicates that the frequency hopping across the repetitions of the PUCCH transmitted via the plurality of component carriers includes transmitting a first set of the repetitions of the PUCCH with frequency hopping across the first set of the repetitions of the PUCCH transmitted via the first component carrier and transmitting a second set of the repetitions of the PUCCH with frequency hopping across the second set of the repetitions of the PUCCH transmitted via the second component carrier.

5. The UE of claim 1, wherein the indication indicates a first PUCCH resource of the first component carrier and a second PUCCH resource of the second component carrier, wherein a configuration of the first PUCCH resource or a format associated with the first PUCCH resource indicates whether to perform frequency hopping across a first set of repetitions of the PUCCH transmitted via the first component carrier, and wherein a configuration of the second PUCCH resource or a format associated with the second PUCCH resource indicates whether to perform frequency hopping across a second set of repetitions of the PUCCH transmitted via the second component carrier.

6. The UE of claim 1, wherein the indication indicates a PUCCH resource of the first component carrier, wherein a configuration of the PUCCH resource indicates a first frequency hop and a second frequency hop for performing frequency hopping across a set of repetitions of the PUCCH transmitted via the first component carrier, and wherein even numbered repetitions of the set of repetitions of the PUCCH are transmitted in the first frequency hop and odd numbered repetitions of the set of repetitions of the PUCCH are transmitted in the second frequency hop.

7. The UE of claim 1, wherein the indication indicates a PUCCH resource of the second component carrier, wherein a configuration of the PUCCH resource indicates a first frequency hop and a second frequency hop for performing frequency hopping across a set of repetitions of the PUCCH transmitted via the second component carrier, and wherein even numbered repetitions of the set of repetitions of the PUCCH are transmitted in the first frequency hop and odd numbered repetitions of the set of repetitions of the PUCCH are transmitted in the second frequency hop.

8. The UE of claim 1, wherein the configuration indicates that the repetitions of the PUCCH are transmitted with frequency hopping across the repetitions in the first component carrier and the second component carrier, and wherein even repetitions of the repetitions of the PUCCH are transmitted in a first frequency hop and odd numbered repetitions of the repetitions of the PUCCH are transmitted in a second frequency hop.

9. The UE of claim 8, wherein a location of the first frequency hop depends on whether a first repetition of the repetitions of the PUCCH is transmitted via the first component carrier or the second component carrier, and wherein a location of the second frequency hop depends on whether a second repetition of the repetitions of the PUCCH is transmitted via the first component carrier or the second component carrier.

10. The UE of claim 1, wherein the indication indicates a first PUCCH resource associated with the first component carrier and a second PUCCH resource associated with the second component carrier, and wherein the configuration indicates that the repetitions of the PUCCH are transmitted with frequency hopping across the repetitions in the first component carrier and the second component carrier based at least in part on:
a configuration of the first PUCCH resource or a format associated with the first PUCCH resource, and
a configuration of the second PUCCH resource or a format associated with the second PUCCH resource.

11. The UE of claim 10, wherein the indication indicates that the repetitions of the PUCCH are transmitted with frequency hopping across the repetitions in the first component carrier and the second component carrier based at least in part on one or more of:
the configuration of the first PUCCH resource or the format associated with the first PUCCH resource indicates that the repetitions of the PUCCH are transmitted with frequency hopping across the repetitions in the first component carrier and the second component carrier, or
the configuration of the second PUCCH resource or the format associated with the second PUCCH resource indicates that the repetitions of the PUCCH are transmitted with frequency hopping across the repetitions in the first component carrier and the second component carrier.

12. The UE of claim 1, wherein one of the first component carrier or the second component carrier corresponds to a reference component carrier, and wherein the configuration indicates that the repetitions of the PUCCH are transmitted with frequency hopping across the repetitions in the first component carrier and the second component carrier when a configuration of a PUCCH resource of the reference component carrier or a format associated with the PUCCH resource of the reference component carrier indicates that the repetitions of the PUCCH are transmitted with frequency hopping across the repetitions in the first component carrier and the second component carrier.

13. The UE of claim 12, wherein the first component carrier corresponds to the reference component carrier when a component carrier index associated with the first component carrier is lower than a component carrier index associated with the second component carrier.

14. A network node for wireless communication, comprising:
a memory; and
one or more processors, coupled to the memory, configured to:
transmit an indication of a configuration for frequency hopping across repetitions of a physical uplink control channel (PUCCH) transmitted via a plurality of component carriers, wherein the plurality of component carriers includes at least a first component carrier and a second component carrier; and
receive the repetitions of the PUCCH in accordance with the configuration.

15. The network node of claim 14, wherein the configuration indicates that the frequency hopping across the repetitions of the PUCCH transmitted via the plurality of component carriers includes transmitting a first set of the repetitions of the PUCCH with frequency hopping across the first set of the repetitions of the PUCCH transmitted via the first component carrier and transmitting a second set of the repetitions of the PUCCH with frequency hopping across the second set of the repetitions of the PUCCH transmitted via the second component carrier.

16. The network node of claim 14, wherein the indication indicates a first PUCCH resource of the first component carrier and a second PUCCH resource of the second component carrier, wherein a configuration of the first PUCCH resource or a format associated with the first PUCCH resource indicates whether to perform frequency hopping across a first set of repetitions of the PUCCH transmitted via the first component carrier, and wherein a configuration of the second PUCCH resource or a format associated with the second PUCCH resource indicates whether to perform frequency hopping across a second set of repetitions of the PUCCH transmitted via the second component carrier.

17. The network node of claim 14, wherein the indication indicates a PUCCH resource of the first component carrier, wherein a configuration of the PUCCH resource indicates a first frequency hop and a second frequency hop for performing frequency hopping across a set of repetitions of the PUCCH transmitted via the first component carrier, and wherein even numbered repetitions of the set of repetitions of the PUCCH are transmitted in the first frequency hop and odd numbered repetitions of the set of repetitions of the PUCCH are transmitted in the second frequency hop.

18. The network node of claim 14, wherein the indication indicates a PUCCH resource of the second component carrier, wherein a configuration of the PUCCH resource indicates a first frequency hop and a second frequency hop for performing frequency hopping across a set of repetitions of the PUCCH transmitted via the second component carrier, and wherein even numbered repetitions of the set of repetitions of the PUCCH are transmitted in the first frequency hop and odd numbered repetitions of the set of repetitions of the PUCCH are transmitted in the second frequency hop.

19. The network node of claim 14, wherein the configuration indicates that the repetitions of the PUCCH are transmitted with frequency hopping across the repetitions in the first component carrier and the second component carrier, and wherein even repetitions of the repetitions of the PUCCH are transmitted in a first frequency hop and odd numbered repetitions of the repetitions of the PUCCH are transmitted in a second frequency hop.

20. The network node of claim 19, wherein a location of the first frequency hop depends on whether a first repetition of the repetitions of the PUCCH is transmitted via the first component carrier or the second component carrier, and wherein a location of the second frequency hop depends on whether a second repetition of the repetitions of the PUCCH is transmitted via the first component carrier or the second component carrier.

21. The network node of claim 19, wherein the indication indicates a first PUCCH resource associated with the first component carrier and a second PUCCH resource associated with the second component carrier, and wherein the configuration indicates that the repetitions of the PUCCH are transmitted with frequency hopping across the repetitions in the first component carrier and the second component carrier based at least in part on:
a configuration of the first PUCCH resource or a format associated with the first PUCCH resource, and
a configuration of the second PUCCH resource or a format associated with the second PUCCH resource.

22. The network node of claim 21, wherein the configuration indicates that the repetitions of the PUCCH are transmitted with frequency hopping across the repetitions in the first component carrier and the second component carrier when one or more of:
the configuration of the first PUCCH resource or the format associated with the first PUCCH resource indicates that the repetitions of the PUCCH are transmitted with frequency hopping across the repetitions in the first component carrier and the second component carrier, or
the configuration of the second PUCCH resource or the format associated with the second PUCCH resource indicates that the repetitions of the PUCCH are transmitted with frequency hopping across the repetitions in the first component carrier and the second component carrier.

23. The network node of claim 21, wherein one of the first component carrier or the second component carrier corresponds to a reference component carrier, and wherein the configuration indicates that the repetitions of the PUCCH are transmitted with frequency hopping across the repetitions in the first component carrier and the second component carrier when a configuration of a PUCCH resource of the reference component carrier or a format associated with the PUCCH resource of the reference component carrier indicates that the repetitions of the PUCCH are transmitted with frequency hopping across the repetitions in the first component carrier and the second component carrier.

24. A UE for wireless communication, comprising:
a memory; and
one or more processors, coupled to the memory, configured to:
receive an indication of a configuration for a first set of repetitions of a physical uplink control channel (PUCCH) transmitted via a first component
carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters; and
transmit the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots.

25. The UE of claim 24, wherein the first set of transmission parameters includes one or more of first spatial relation information, a first uplink beam, or a first set of power control parameters, and wherein the second set of transmission parameters includes one or more of second spatial relation information, a second uplink beam, or a second set of power control parameters.

26. The UE of claim 24, wherein the one or more processors are further configured to:
receive a media access control control element (MAC-CE) activating the first set of transmission parameters and the second set of transmission parameters for the at least one of the first PUCCH resource or the second PUCCH resource.

27. The UE of claim 24, wherein the first set of repetitions of the PUCCH is transmitted with the first set of transmission parameters and the second set of transmission parameters at different slots or at different sub-slots according to a first mapping pattern and the second set of repetitions of the PUCCH is transmitted with a third set of transmission parameters and a fourth set of transmission parameters at different slots or at different sub-slots according to a second mapping pattern when the first PUCCH resource is activated with the first set of transmission parameters and the second set of transmission parameters and the second PUCCH resource is activated with the third set of transmission parameters and the fourth set of transmission parameters, and wherein the first mapping pattern and the second mapping pattern are separately applied to the first set of repetitions of the PUCCH and the second set of repetitions of the PUCCH, respectively.

28. The UE of claim 27, wherein a configuration of the first component carrier or a configuration of the first PUCCH resource or a format associated with the first PUCCH resource indicates the first mapping pattern, and wherein a configuration of the second component carrier or a configuration of the second PUCCH resource or a format associated with the second PUCCH resource indicates the second mapping pattern.

29. The UE of claim 27, wherein:
the first mapping pattern comprises a cyclic mapping pattern and the second mapping pattern comprises the cyclic mapping pattern,
the first mapping pattern comprises a cyclic mapping pattern and the second mapping pattern comprises to a sequential mapping pattern,
the first mapping pattern comprises the sequential mapping pattern and the second mapping pattern comprises to the cyclic mapping pattern, or
the first mapping pattern comprises the sequential mapping pattern and the second mapping pattern comprises to the sequential mapping pattern.

30. A network node for wireless communication, comprising:
a memory; and
one or more processors, coupled to the memory, configured to:
transmit an indication of a configuration for a first set of repetitions of a physical uplink control channel (PUCCH) transmitted via a first component carrier and a second set of repetitions of the PUCCH transmitted via a second component carrier, wherein at least one of a first PUCCH resource of the first component carrier or a second PUCCH resource of the second component carrier is activated with a first set of transmission parameters and a second set of transmission parameters; and
receive the first set of repetitions of the PUCCH and the second set of repetitions of the PUCCH in accordance with the configuration, wherein at least one of the first set of repetitions of the PUCCH or the second set of repetitions is transmitted with the first set of transmission parameters and the second set of transmission parameters at different slots or at different sub-slots.
